(19) United States
(12) Patent Application Publication
(10) Pub. No.: US 2023/0167007 A1
(43) Pub. Date: Jun. 1, 2023

(54) GLASS FOR PHARMACEUTICAL CONTAINER, GLASS TUBE FOR PHARMACEUTICAL CONTAINER, AND PHARMACEUTICAL CONTAINER

(71) Applicant: NIPPON ELECTRIC GLASS CO., LTD., Otsu-shi, Shiga (JP)

(72) Inventor: Satoshi ARAI, Otsu-shi, Shiga (JP)

(73) Assignee: NIPPON ELECTRIC GLASS CO., LTD., Otsu-shi, Shiga (JP)

(21) Appl. No.: 17/912,072

(22) PCT Filed: Apr. 13, 2021
(86) PCT No.: PCT/JP2021/015340

§ 371 Date: Sep. 16, 2022

(30) Foreign Application Priority Data
Apr. 30, 2020 (JP) 2020-080013

(51) Int. Cl. C03C 3/091; C03C 4/20

(52) U.S. Cl. CPC C03C 3/091; C03C 4/20; C03C 2201/32

(57) ABSTRACT

A glass for a pharmaceutical container of the present invention contains, as a glass composition, in terms of mol %, 70% to 85% of SiO₂, 3% to 13% of Al₂O₃, 0% to 5% of B₂O₃, 0.1% to 18% of Li₂O+Na₂O+K₂O, and 0% to 10% of MgO+CaO+SrO+BaO, in which a molar ratio (Li₂O+Na₂O+K₂O)/Al₂O₃ is 1 or more and a molar ratio (Li₂O+Na₂O+K₂O+MgO+CaO+SrO+BaO—Al₂O₃)/(SiO₂+Al₂O₃) is 0.2 or less.

### TECHNICAL FIELD

The present invention relates to a glass for a pharmaceutical container, a glass tube for a pharmaceutical container, and a pharmaceutical container, which have excellent processability and hydrolytic resistance.

### BACKGROUND ART

In related art, various glass containers have been used as pharmaceutical containers.

Pharmaceuticals are roughly classified into two types of oral agents and parenteral agents. In particular, in the case of a parenteral agent, a medicament filled and stored in a glass container is directly administered into the blood of a patient. Therefore, a glass container filled with parenteral agents is required to have very high quality.

In addition, it is required that ingredients of a medicament filled in a pharmaceutical container are not changed in quality. When a glass component is eluted into the medicament, properties of the medicament may be changed, which may affect the health and even life of the patient. Therefore, in each country pharmacopoeia, an elution amount of the glass component from the glass container is limited.

### CITATION LIST

### Patent Literature

Patent Literature 1: WO 2013/063275 A1

### SUMMARY OF INVENTION

### Technical Problem

In recent years, with the development of medicine and pharmacology, medicaments having high medicinal efficacy have been developed. However, when such medicaments are filled and stored in a glass container formed of borosilicate glass, the inner surface of the glass container may be eroded and peeled off to cause a phenomenon of floating in the medicaments as flakes, so-called delamination. When an insoluble foreign matter generated due to delamination or the like is injected into the body of a patient together with a medicament, a fatal problem such as formation of thrombus in a blood vessel may occur.

In addition, since the glass for a pharmaceutical container is processed into a complicated shape such as an ampoule, a vial, a prefilled syringe, and a cartridge, it is also desired that the working temperature at the time of processing is low.

For example, Patent Literature 1 describes that when a content of B₂O₃ in a glass composition is reduced, delamination can be prevented. However, in this case, the glass component is evaporated at the time of processing and contaminates the inner surface of the glass container and the medicament since the viscosity of the glass is increased and the working temperature at the time of processing is increased. Meanwhile, the glass described in Patent Literature 1 contains a large amount of Na₂O in the glass composition in order to lower the working temperature during processing, but in this case, the hydrolytic resistance deteriorates. In short, it is difficult for the glass described in Patent Literature 1 to achieve both the hydrolytic resistance and processability.

In view of the above circumstances, a technical object of the present invention is to provide a glass for a pharmaceutical container, a glass tube for a pharmaceutical container, and a pharmaceutical container, in which a content of B₂O₃ in a glass composition is small and which can achieve both hydrolytic resistance and processability.

### Solution to Problem

As a result of intensive studies, the present inventors have found that the above-described problems can be solved by strictly regulating the content of each glass component, and have proposed the present invention. That is, a glass for a pharmaceutical container of the present invention contains, as a glass composition, in terms of mol %, 70% to 85% of SiO₂, 3% to 13% of Al₂O₃, 0% to 5% of B₂O₃, 0.1% to 18% of Li₂O+Na₂O+K₂O, and 0% to 10% of MgO+CaO+SrO+BaO, in which a molar ratio (Li₂O+Na₂O+K₂O)/Al₂O₃ is 1 or more and a molar ratio (Li₂O+Na₂O+K₂O+MgO+CaO+SrO+BaO—Al₂O₃)/(SiO₂+Al₂O₃) is 0.2 or less. This makes it possible to achieve both hydrolytic resistance and processability while preventing delamination.

Here, “Li₂O+Na₂O+K₂O” refers to a total content of Li₂O, Na₂O, and K₂O. “MgO+CaO+SrO+BaO” refers to a total content of MgO, CaO, SrO, and BaO. “(Li₂O+Na₂O+K₂O)/Al₂O₃” refers to a value obtained by dividing the total content of Li₂O, Na₂O, and K₂O by the content of Al₂O₃. “(Li₂O+Na₂O+K₂O+MgO+CaO+SrO+BaO—Al₂O₃)/(SiO₂+Al₂O₃)” refers to a value obtained by dividing a content, which is obtained by subtracting the content of Al₂O₃ from the total content of Li₂O, Na₂O, K₂O, MgO, CaO, SrO and BaO, by the total content of SiO₂ and Al₂O₃.

In the glass for a pharmaceutical container of the present invention, the content of Li₂O is preferably 0 mol % to 8.1 mol %, the content of Na₂O is preferably 0.1 mol % to 8 mol %, and the content of K₂O is preferably 0.01 mol % to 5 mol %. As a result, the hydrolytic resistance can be effectively enhanced.

In the glass for a pharmaceutical container of the present invention, the content of MgO+CaO+SrO+BaO is preferably 0 mol % to 5 mol %. As a result, the hydrolytic resistance can be effectively enhanced.

In the glass for a pharmaceutical container of the present invention, the content of MgO is preferably 0 mol % to 1.5 mol %, the content of CaO is preferably 0 mol % to 4 mol %, the content of SrO is preferably 0 mol % to 0.3 mol %, and the content of BaO is preferably 0 mol % to 0.3 mol %. As a result, the hydrolytic resistance can be effectively enhanced.

In the glass for a pharmaceutical container of the present invention, a molar ratio Li₂O/(Li₂O+Na₂O+K₂O) is preferably 0.6 or less. Here, “Li₂O/(Li₂O+Na₂O+K₂O)” refers to a value obtained by dividing the content of Li₂O by the total content of Li₂O, Na₂O, and K₂O.

In the glass for a pharmaceutical container of the present invention, a molar ratio (Li₂O+Na₂O+K₂O)/Al₂O₃ is preferably 2 or more. Thus, processability can be enhanced.

In the glass for a pharmaceutical container of the present invention, a molar ratio CaO/(Li₂O+Na₂O+K₂O+MgO+CaO+SrO+BaO) is preferably less than 0.018. Here, “CaO/(Li₂O+Na₂O+K₂O+MgO+CaO+SrO+BaO)” refers to a value obtained by dividing the content of CaO by the total content of Li₂O, Na₂O, K₂O, MgO, CaO, SrO, and BaO.

The glass for a pharmaceutical container of the present invention preferably contains CaO. A molar ratio Li₂O/CaO is preferably 3.1 or less. This makes it liable to achieve both the hydrolytic resistance and processability. Here, “Li₂O/CaO” refers to a value obtained by dividing the content of Li₂O by the content of CaO.

In the glass for a pharmaceutical container of the present invention, the content of SiO₂+Al₂O₃+Li₂O+Na₂O+K₂O+MgO+CaO+SrO+BaO is preferably 90 mol % or more. This makes it liable to achieve both the hydrolytic resistance and processability. Here, “SiO₂+Al₂O₃+Li₂O+Na₂O+K₂O+MgO+CaO+SrO+BaO” refers to the total content of Li₂O, Na₂O, K₂O, MgO, CaO, SrO and BaO.

In the glass for a pharmaceutical container of the present invention, the content of B₂O₃ is preferably 0.01 mol % to 1 mol %. Accordingly, it is possible to enhance the processability while preventing the occurrence of delamination.

In the glass for a pharmaceutical container of the present invention, the content of ZrO₂ is preferably 0 mol % to 2 mol %.

A glass for a pharmaceutical container of the present invention contains, as a glass composition, in terms of mol %, 70% to 85% of SiO₂, 3% to 10% of Al₂O₃, 0% to 5% of B₂O₃, 0.1% to less than 13.9% of Li₂O+Na₂O+K₂O, and 0% to 10% of MgO+CaO+SrO+BaO, in which a molar ratio Li₂O/(Li₂O+Na₂O+K₂O) is 0.5 or less, a molar ratio (Li₂O+Na₂O+K₂O)/Al₂O₃ is 2.0 or more, a molar ratio (Li₂O+Na₂O+K₂O+MgO+CaO+SrO+BaO—Al₂O₃)/(SiO₂+Al₂O₃) is 0.156 or less, and a molar ratio CaO/(Li₂O+Na₂O+K₂O+MgO+CaO+SrO+BaO) is less than 0.018.

A glass for a pharmaceutical container of the present invention contains, as a glass composition, in terms of mol %, 70% to 85% of SiO₂, 3% to 10% of Al₂O₃, 0% to 5% of B₂O₃, 0.1% to less than 13.9% of Li₂O+Na₂O+K₂O, and CaO, in which a molar ratio Li₂O/(Li₂O+Na₂O+K₂O) is 0.5 or less, a molar ratio (Li₂O+Na₂O+K₂O)/Al₂O₃ is 2.0 or more, a molar ratio (Li₂O+Na₂O+K₂O+MgO+CaO+SrO+BaO—Al₂O₃)/(SiO₂+Al₂O₃) is 0.156 or less, and a molar ratio Li₂O/CaO is 3.1 or less.

In the glass for a pharmaceutical container of the present invention, a molar ratio (MgO+CaO+SrO+BaO)/(Li₂O+Na₂O+K₂O+MgO+CaO+SrO+BaO) is preferably 0.06 or less. “(MgO+CaO+SrO+BaO)/(Li₂O+Na₂O+K₂O+MgO+CaO+SrO+BaO)” refers to a value obtained by dividing the total content of MgO, CaO, SrO and BaO by the total content of Li₂O, Na₂O, K₂O, MgO, CaO, SrO and BaO.

A glass for a pharmaceutical container of the present invention contains, as a glass composition, in terms of mol %, 75% to 85% of SiO₂, 3% to 13% of Al₂O₃, 0% to 4% of B₂O₃, 0.11% to 16% of Li₂O+Na₂O+K₂O, 0.1% to 15% of Na₂O, and 0.01% to 5% of K₂O, in which a molar ratio (Li₂O+Na₂O+K₂O)/Al₂O₃ is 2 or more, a molar ratio (MgO+CaO+SrO+BaO)/(Li₂O+Na₂O+K₂O+MgO+CaO+SrO+BaO) is 0.06 or less, and a molar ratio (Li₂O+Na₂O+K₂O+MgO+CaO+SrO+BaO—Al₂O₃)/(SiO₂+Al₂O₃) is 0.2 or less.

In the glass for a pharmaceutical container of the present invention, a molar ratio CaO/(MgO+CaO+SrO+BaO) is preferably 0.5 or more. As a result, the hydrolytic resistance can be enhanced.

A glass for a pharmaceutical container of the present invention contains, as a glass composition, in terms of mol %, 70% to 85% of SiO₂, 3% to 13% of Al₂O₃, 0% to 5% of B₂O₃, 0.1% to 16% of Li₂O+Na₂O+K₂O, 0.1% to 15% of Na₂O, and 0.1% to 5% of MgO+CaO+SrO+BaO, in which a molar ratio (Li₂O+Na₂O+K₂O)/Al₂O₃ is 2 or more, a molar ratio CaO/(MgO+CaO+SrO+BaO) is 0.5 or more, and a molar ratio (Li₂O+Na₂O+K₂O+MgO+CaO+SrO+BaO—Al₂O₃)/(SiO₂+Al₂O₃) is 0.2 or less. Here, “CaO/(MgO+CaO+SrO+BaO)” refers to a value obtained by dividing the content of CaO by the total content of MgO, CaO, SrO, and BaO.

In the glass for a pharmaceutical container of the present invention, a molar ratio SiO₂/Al₂O₃ is preferably 10 or more. Here, “SiO₂/Al₂O₃” refers to a value obtained by dividing the content of SiO₂ by the content of Al₂O₃.

A glass for a pharmaceutical container of the present invention contains, as a glass composition, in terms of mol %, 70% to 85% of SiO₂, 3% to 13% of Al₂O₃, 0% to 5% of B₂O₃, 0.21% to 16% of Li₂O+Na₂O+K₂O, 0.1% to 10% of Li₂O, 0.1% to 15% of Na₂O, 0.01% to 5% of K₂O, and 0% to 6% of MgO+CaO+SrO+BaO, in which a molar ratio (Li₂O+Na₂O+K₂O)/Al₂O₃ is 1 or more, a molar ratio SiO₂/Al₂O₃ is more than 13.2, and a molar ratio (Li₂O+Na₂O+K₂O+MgO+CaO+SrO+BaO—Al₂O₃)/(SiO₂+Al₂O₃) is less than 0.155.

In the glass for a pharmaceutical container of the present invention, the class in a hydrolytic resistance test (acetone washing) according to ISO 720 is preferably at least HGA 1. Here, the “hydrolytic resistance test (acetone washing) according to ISO 720” refers to the following test.

(1) A glass sample is ground in an alumina mortar and classified into a size of 300 μm to 425 μm with a sieve.

(2) The obtained powder sample is washed with acetone and dried in an oven at 140° C.

(3) 10 g of the dried powder sample is placed in a quartz flask, 50 mL of purified water is further added thereto, the flask is covered, followed by treating in an autoclave. The treatment is performed under treatment conditions of increasing the temperature from 100° C. to 121° C. at a rate of 1° C./min, then holding the temperature at 121° C. for 30 minutes, and lowering the temperature to 100° C. at a rate of 0.5° C./min.

(4) After the autoclave treatment, the solution in the quartz flask is transferred to another beaker, the inside of the quartz flask is further washed three times with 15 mL of purified water, and the washing liquid is also added to the beaker.

(5) A methyl red indicator is added to the beaker, and the mixture is titrated with a 0.02 mol/L hydrochloric acid aqueous solution.

(6) The amount of the 0.02 mol/L hydrochloric acid aqueous solution consumed for the titration is converted to an elution amount of alkali per 1 g of glass by assuming that 1 mL of 0.02 mol/L hydrochloric acid aqueous solution is equivalent to 620 μg of Na₂O.

The expression “the class in a hydrolytic resistance test (acetone washing) according to ISO 720 is at least HGA1” means that the elution amount of alkali per 1 g of glass in terms of Na₂O determined by the above test is 62 μg/g or less.

In the glass for a pharmaceutical container of the present invention, the working point is preferably 1300° C. or less. Here, the “working point” refers to a temperature at which the viscosity of the glass becomes 10⁴⁰ dPas.

A glass tube for a pharmaceutical container of the present invention is preferably formed of the above-described glass for a pharmaceutical container.

A pharmaceutical container of the present invention is preferably formed of the above-described glass for a pharmaceutical container.

### BRIEF DESCRIPTION OF DRAWINGS

FIG. 1 is a graph obtained by plotting molar ratios (Li₂O+Na₂O+K₂O+MgO+CaO+SrO+BaO—Al₂O₃)/(SiO₂+Al₂O₃) of the glass samples on a horizontal axis, and hydrolytic resistance test data on a vertical axis, in which R′O in the figure represents MgO+CaO+SrO+BaO.

FIG. 2 is a graph showing the presence or absence of MgO+CaO+SrO+BaO in different plots in FIG. 1.

FIG. 3 is a graph showing data of glass not containing MgO+CaO+SrO+BaO extracted from data shown in FIG. 1.

FIG. 4 is a graph showing data of glass containing MgO+CaO+SrO+BaO extracted from the data shown in FIG. 1.

### DESCRIPTION OF EMBODIMENTS

The reason why the content range of each ingredient is limited will be described. In the following description, “%” means “mol %” unless otherwise specified.

SiO₂ is one of ingredients constituting a network structure of glass. As the content of SiO₂ is small, the processability is improved. However, when the content of SiO₂ is too small, the hydrolytic resistance is liable to deteriorate, the vitrification becomes difficult, the thermal expansion coefficient increases, and the thermal impact resistance is liable to decrease. Meanwhile, as the content of SiO₂ is large, the hydrolytic resistance is improved. However, when the content of SiO₂ is too large, the viscosity of the glass increases, the processability is liable to decrease, the liquidus temperature increases, and the glass is liable to devitrify. Therefore, the content of SiO₂ is 70% to 85%, preferably 71% to 84%, 72% to 83%, 73% to 82.5%, 74% to 82%, 75% to 81.5%, particularly preferably 76% to 81%.

Al₂O₃ is one of ingredients constituting a network structure of glass, and has an effect of improving the hydrolytic resistance. When the content of Al₂O₃ is too small, the hydrolytic resistance is liable to decrease. Meanwhile, when the content of Al₂O₃ is too large, the viscosity of the glass increases. Therefore, the content of Al₂O₃ is 3% to 13%, preferably 3.5% to 12%, 3.6% to 11%, 3.7% to 10%, 3.8% to 9.5%, 3.9% to 9%, 4% to 8.5%, 4.1% to 8%, 4.2% to 7.8%, 4.3% to 7.5%, 4.4% to 7.3%, particularly preferably 4.5% to 7%.

B₂O₃ has an effect of decreasing the viscosity of the glass to enhance the meltability and processability. However, B₂O₃ is considered to be one of the factors causing delamination. When the content thereof is too large, the delamination resistance deteriorates, and flakes are liable to occur. Therefore, the content of B₂O₃ is 0% to 5%, preferably 0.01% to 4%, 0.02% to 3%, 0.03% to 2%, 0.04% to 1%, 0.04% to 0.8%, particularly preferably 0.05% to 0.5%.

Li₂O, Na₂O, and K₂O, which are alkali metal oxides (R₂O), are ingredients that break the network structure of the glass, and have an effect of decreasing the viscosity of the glass to enhance the processability and meltability. The lower limit range of the content of Li₂O+Na₂O+K₂O is 0.1% or more, preferably 0.11% or more, 0.21% or more, 0.5% or more, 1% or more, 2% or more, 3% or more, 4% or more, 4.5% or more, 5% or more, 5.5% or more, 6% or more, 6.5% or more, 7% or more, 7.5% or more, particularly preferably 8% or more. When particularly emphasizing the processability, the lower limit range of the content of Li₂O+Na₂O+K₂O is preferably 8.5% or more, 9% or more, 9.5% or more, 10% or more, 10.5% or more, or 11% or more. Meanwhile, when the content of Li₂O+Na₂O+K₂O is too large, the hydrolytic resistance deteriorates, the thermal expansion coefficient increases, and the thermal impact resistance decreases. Therefore, the upper limit range of the content of Li₂O+Na₂O+K₂O is 18% or less, preferably 17% or less, 16.1% or less, 16% or less, 15.9% or less, 15.5% or less, 15% or less, 14.5% or less, 14% or less, 14.0% or less, 13.9% or less, less than 13.9%, 13.8% or less, less than 13.8%, 13.7% or less, 13.5% or less, particularly preferably 13% or less.

As described above, Li₂O has an effect of decreasing the viscosity of the glass to enhance the processability and the meltability. Among the alkali metal oxides, Li₂O has the highest effect of decreasing the viscosity of the glass, followed by Na₂O and K₂O in that order. However, when the content of Li₂O is too large, the hydrolytic resistance is liable to deteriorate. Therefore, the content of Li₂O is preferably 0% to 9%, 0 to 8.1%, 0% to 8%, 0% to 7%, 0% to 6.8%, 0% to 6.5%, 0% to 6.3%, 0% to 6%, 0% to 5.9%, 0% to 5.8%, 0% to 5.7%, 0% to 5.5%, 0% to 5.0%, 0% to 4.9%, particularly preferably 0% to 4.8%. When the content of Li₂O is 6% or less, devitrification is less likely to occur.

When emphasizing the processability, the content of Li₂O is preferably 0.1% to 9%, 0.5% to 8%, 1% to 7.5%, 2% to 7.4%, 2.5% to 7.3%, 3% to 7.2%, 3.5% to 7.1%, particularly preferably 4% to 7%.

When emphasizing both the hydrolytic resistance and the processability, the content of Li₂O is preferably 2% to 8%, 2.5% to 7%, 3% to 6.5%, 3.1% to 6.3%, 3.3% to 6.2%, 3.5% to 6.1%, particularly preferably 4% to 6%.

Like Li₂O, Na₂O has an effect of decreasing the viscosity of the glass to enhance the processability and meltability. When the content of Na₂O is too small, the devitrification resistance may decrease. Meanwhile, when the content of Na₂O is too large, the hydrolytic resistance is liable to deteriorate. Therefore, the content of Na₂O is preferably 0% to 12%, 0% to 10%, 0% to 9%, 0% to 8.5%, 0% to 8.3%, 0% to 8%, 0% to 7.9%, 0% to 7.5%, 0% to 7%, 0% to 6.5%, 0% to 6%, 0% to 5.5%, particularly preferably 0% to 5%.

When emphasizing the processability, the content of Na₂O is preferably 0.1% to 12%, 0.5% to 11%, 1% to 10%, 2% to 9%, 2.5% to 8.5%, 3% to 8%, 3.3% to 7.5%, 3.5% to 7%, 3.8% to 6.5%, particularly preferably 4% to 6%.

K₂O has an effect of decreasing the viscosity of the glass to enhance the processability and meltability, though not as much as the effect of Li₂O and Na₂O. However, when the content of K₂O is too large, the hydrolytic resistance is liable to deteriorate. Meanwhile, when the content of K₂O is too small, the devitrification resistance may decrease. Therefore, the content of K₂O is preferably 0% to 5%, 0% to 4%, 0% to 3.8%, 0% to 3.7%, 0% to 3.6%, 0% to 3.5%, 0% to 3.3%, 0% to 3.1%, 0% to 3%, particularly preferably 0% to less than 3%.

When emphasizing the processability, the content of K₂O is preferably 0.01% to 11%, 0.05% to 10%, 0.1% to 8%, 0.5% to 6%, 0.8% to 5.5%, 1% to 5%, 1.2% to 4.5%, 1.4% to 4.3%, particularly preferably 1.5% to 4%.

Among the alkali metal oxides (R₂O), Li₂O has the highest effect of decreasing the viscosity of the glass, followed by Na₂O and K₂O in that order. Therefore, from the viewpoint of decreasing the viscosity of the glass, the relationship of the content of the alkali metal oxides is preferably Li₂O≥Na₂O≥K₂O, Li₂O≥Na₂O>K₂O or Li₂O>Na₂O≥K₂O, and particularly preferably Li₂O>Na₂O>K₂O. When the proportion of K₂O in the alkali metal oxides is too high, it is difficult to achieve both the hydrolytic resistance and processability. Therefore, from the viewpoint of achieving both the hydrolytic resistance and processability, Na₂O>K₂O is preferable.

When the proportion of Li₂O in the alkali metal oxides is too high, the devitrification resistance is liable to decrease. Therefore, from the viewpoint of devitrification resistance, the relationship of the content of the alkali metal oxides is preferably Na₂O>Li₂O. K₂O has the highest effect of improving the devitrification resistance, followed by Na₂O and Li₂O in that order. From the viewpoint of achieving both the hydrolytic resistance and devitrification resistance, it is preferably Li₂O≥Na₂O≥K₂O, Li₂O≥K₂O>Na₂O or Li₂O>Na₂O≥K₂O, particularly preferably Li₂O>K₂O>Na₂O.

As described above, when the proportion of Li₂O in the alkali metal oxides is too high, the devitrification resistance is liable to decrease. Therefore, from the viewpoint of the devitrification resistance, the upper limit range of a molar ratio Li₂O/(Li₂O+Na₂O+K₂O) is preferably 0.8 or less, 0.7 or less, 0.6 or less, 0.55 or less, 0.54 or less, 0.53 or less, 0.52 or less, 0.51 or less, 0.5 or less, less than 0.50, 0.49 or less, 0.48 or less, 0.47 or less, 0.46 or less, particularly preferably 0.45 or less.

When the proportion of K₂O in the alkali metal oxides is too high, the effect of decreasing the viscosity of the glass is reduced. Therefore, the upper limit range of a molar ratio K₂O/(Li₂O+Na₂O+K₂O) is preferably 0.6 or less, 0.5 or less, 0.4 or less, 0.24 or less, 0.22 or less, 0.21 or less, particularly preferably 0.2 or less. Meanwhile, when the molar ratio K₂O/(Li₂O+Na₂O+K₂O) is too small, the devitrification resistance may decrease. Therefore, the lower limit range of the molar ratio K₂O/(Li₂O+Na₂O+K₂O) is preferably more than 0, 0.01 or more, particularly 0.03 or more, 0.05 or more, 0.8 or more, 0.1 or more, particularly preferably 0.13 or more.

When the content of Al₂O₃ is large, the hydrolytic resistance is improved, but the viscosity of the glass increases. When the content of Li₂O+Na₂O+K₂O is large, the viscosity of the glass decreases, but the hydrolytic resistance deteriorates. Therefore, a molar ratio Al₂O₃/(Li₂O+Na₂O+K₂O) is preferably 50 or less, 40 or less, 30 or less, 20 or less, 10 or less, 5 or less, 3 or less, 2 or less, 1.2 or less, 0 to 1, 0 to 0.85, 0 to 0.8, more than 0 to 0.74, 0.01 to 0.7, 0.1 to 0.67, 0.2 to 0.65, 0.3 to 0.61, 0.35 to 0.60, 0.4 to 0.59, particularly preferably more than 0.4 to 0.55. When the molar ratio Al₂O₃/(Li₂O+Na₂O+K₂O) is out of the above range, it is difficult to achieve both the hydrolytic resistance and the processability. When the molar ratio Al₂O₃/(Li₂O+Na₂O+K₂O) is 0.67 or less, both the hydrolytic resistance and processability are particularly liable to be achieved.

As described above, the alkali metal oxide is an ingredient that decreases the viscosity of the glass and at the same time deteriorates the chemical durability. This is because the alkali metal oxide cuts the network structure of the glass. However, Al₂O₃ forms a network structure of glass together with the alkali metal oxide in glass. Therefore, when Al₂O₃ is introduced into the glass composition, the role of a part of the alkali metal oxide can be changed from cutting the network structure to forming the network structure. From this, from the viewpoint of emphasizing the hydrolytic resistance, it is preferable that all Al₂O₃ forms a bond together with the alkali metal oxide in a stoichiometric ratio. This state is when the value of the molar ratio (Li₂O+Na₂O+K₂O)/Al₂O₃ is 1 or more. Therefore, as the value of the molar ratio (Li₂O+Na₂O+K₂O)/Al₂O₃ is closer to 1, the network structure increases, and thus the hydrolytic resistance is improved. Meanwhile, in this state, the processability decreases since the amount of the alkali metal oxide is small. Therefore, from the viewpoint of achieving both the hydrolytic resistance and processability, the lower limit range of the molar ratio (Li₂O+Na₂O+K₂O)/Al₂O₃ is 1 or more, preferably 1.5 or more, 1.6 or more, 1.7 or more, 1.8 or more, 1.9 or more, 2 or more, 2.0 or more, 2.1 or more, 2.2 or more, 2.3 or more, 2.4 or more, particularly preferably 2.5 or more. Meanwhile, when the molar ratio (Li₂O+Na₂O+K₂O)/Al₂O₃ is too large, the processability is improved, but the hydrolytic resistance is liable to deteriorate. Therefore, the upper limit range of the molar ratio (Li₂O+Na₂O+K₂O)/Al₂O₃ is preferably 5 or less, 4 or less, 3.5 or less, 3.4 or less, 3.3 or less, 3.2 or less, 3.1 or less, particularly preferably 3 or less.

When the content of Al₂O₃ is too small with respect to SiO₂, the hydrolytic resistance is liable to deteriorate and the devitrification resistance is also liable to deteriorate. Therefore, the upper limit range of a molar ratio SiO₂/Al₂O₃ is preferably 30 or less, 25 or less, 20 or less, 18 or less, 17 or less, 16 or less, particularly preferably 15 or less. When the content of Al₂O₃ is too large with respect to SiO₂, it becomes difficult to achieve both the hydrolytic resistance and processability. Therefore, the lower limit range of the molar ratio SiO₂/Al₂O₃ is preferably 10 or more, 11 or more, 12 or more, 12.5 or more, 12.8 or more, 12.9 or more, 13 or more, 13.0 or more, 13.1 or more, or 13.2 or more, particularly preferably more than 13.2.

In order to achieve both the hydrolytic resistance and processability, it is preferable to regulate the ingredient balance between SiO₂ and the alkali metal oxides. A molar ratio SiO₂/(Li₂O+Na₂O+K₂O) is preferably 10 or less, 8 or less, 7.9 or less, 7 or less, 6.9 or less, 6.5 or less, 6.1 or less, 6.0 or less, 5.9 or less, particularly preferably 5.8 or less. In particular, when the molar ratio SiO₂/(Li₂O+Na₂O+K₂O) is 6.9 or less, both the hydrolytic resistance and processability are particularly liable to be achieved.

The lower limit range of a molar ratio Li₂O/(Na₂O+K₂O) is preferably 0.1 or more, 0.2 or more, 0.3 or more, 0.4 or more, 0.5 or more, 0.6 or more, particularly preferably 0.7 or more. This makes it possible to prevent the adverse effects of Na₂O, which deteriorates the hydrolytic resistance, while accurately enjoying the effects of Li₂O. Meanwhile, when the molar ratio Li₂O/(Na₂O+K₂O) is too large, the raw material cost increases. Therefore, the upper limit range of the molar ratio Li₂O/(Na₂O+K₂O) is preferably 2.0 or less, 1.5 or less, 1.2 or less, 1.1 or less, 1.0 or less, less than 1.0, 0.9 or less, 0.85 or less, 0.83 or less, particularly preferably 0.82 or less.

MgO, CaO, SrO, and BaO, which are alkaline earth metal oxides (R′O), are ingredients that break the network structure of the glass in the same manner as the alkali metal oxides, and also have the effect of decreasing the viscosity of the glass. In addition, MgO, CaO, SrO, and BaO are ingredients that also affect the hydrolytic resistance. When the content of MgO+CaO+SrO+BaO is too large, not only the hydrolytic resistance is liable to deteriorate, but also the devitrification resistance is liable to decrease, and the alkaline earth metal oxides eluted into the medicament may be precipitated as carbonate or sulfate. Therefore, the content of MgO+CaO+SrO+BaO is 0% to 10%, preferably 0% to 5%, 0% to 4%, 0% to 3.7%, 0% to 3%, 0% to 2%, 0% to 1%, 0% to 0.9%, 0% to 0.8%, 0% to 0.7%, 0% to 0.6%, 0% to 0.5%, 0% to 0.4%, 0% to 0.3%, 0% to 0.2%, 0% to 0.1%, 0% to 0.01%, less than 0.01%, particularly preferably less than 0.001%, from the viewpoint of emphasizing the hydrolytic resistance. From the viewpoint of emphasizing the processability, the content of MgO+CaO+SrO+BaO is preferably 0.01% to 11%, 0.05% to 10%, 0.1% to 9%, 0.5% to 8%, 0.7% to 7%, 0.9% to 6%, 1.0% to 5%, more than 1% to 4.9%, 1.1% to 4.8%, 1.2% to 4.7%, 1.3% to 4.6%, 1.4% to 4.3%, particularly 1.5% to 4%, 1.8% to less than 4%, particularly preferably 1.9% to 3.8%.

The degree of precipitation of carbonate or sulfate of the alkaline earth metal oxides depends on the solubility of each salt. Specifically, the solubility of MgO is the highest, followed by CaO, SrO, and BaO in that order. That is, MgO is most unlikely to cause the precipitation of the salt, and BaO is most likely to cause the precipitation of the salt. Therefore, when focusing on the solubility, the relationship of the content between alkaline earth metal oxides is preferably MgO≥CaO (particularly MgO>CaO), MgO≥SrO (particularly MgO>SrO), MgO≥BaO (particularly MgO>BaO), CaO≥SrO (particularly CaO>SrO), CaO≥BaO (particularly CaO>BaO), or SrO≥BaO (particularly SrO>BaO), more preferably MgO≥CaO≥SrO≥BaO, and still more preferably MgO>CaO>SrO>BaO.

Meanwhile, BaO has the highest effect of decreasing the viscosity of glass, followed by SrO, CaO, and MgO in that order. Therefore, when focusing on the processability, the relationship of the content between the alkaline earth metal oxides is preferably MgO≤CaO (particularly MgO<CaO), MgO≤SrO (particularly MgO<SrO), MgO≤BaO (particularly MgO<BaO), CaO≤SrO (particularly CaO<SrO), CaO≤BaO (particularly CaO<BaO), or SrO≤BaO (particularly SrO<BaO), more preferably MgO≤CaO≤SrO≤BaO, and still more preferably MgO<CaO<SrO<BaO.

As described above, MgO is an ingredient that cause high solubility of carbonate and sulfate and is unlikely to cause salt precipitation. However, since Mg ions are liable to react with hydrated silicic acid, hydrated silicic acid generated on the glass surface and Mg ions may react with each other to form an insoluble magnesium silicate hydrate film when Mg ions in the glass are eluted. This film may be peeled off by vibration or the like to become a flaky insoluble foreign matter. Meanwhile, when the content of MgO is too large, the hydrolytic resistance is liable to deteriorate. Therefore, the content of MgO is preferably 0% to 10%, 0% to 8%, 0% to 5%, 0% to 3%, 0% to 1.5%, 0% to 1%, 0% to 0.9%, 0% to 0.8%, 0% to 0.7%, 0% to 0.6%, 0% to 0.5%, 0% to 0.4%, 0% to 0.3%, 0% to 0.2%, 0% to 0.1%, 0% to 0.05%, 0% to 0.03%, 0% to less than 0.03%, 0% to 0.01%, 0% to less than 0.01%, particularly preferably 0% to less than 0.001%. When emphasizing the processability, MgO may be introduced in an amount of 0.01% or more.

Among the alkaline earth metal oxides, CaO is an ingredient that can achieve both a decrease in the viscosity of glass and a difficulty in precipitation of salts and insoluble foreign matters. However, when the content of CaO is too large, the hydrolytic resistance may decrease. Therefore, the content of CaO is preferably 0% to 10%, 0% to 8%, 0% to 5%, 0% to 3%, 0% to 1%, 0% to 0.9%, 0% to 0.8%, 0% to 0.7%, 0% to 0.6%, 0% to 0.5%, 0% to 0.4%, 0% to 0.3%, 0% to 0.2%, 0% to 0.1%, 0% to 0.05%, 0% to 0.03%, 0% to less than 0.03%, 0% to 0.01%, 0% to less than 0.01%, particularly preferably 0% to less than 0.001%. From the viewpoint of emphasizing the processability, CaO is preferably contained. The content of CaO is preferably more than 0% to 10%, 1% to 10%, 1.2% to 9%, 1.4% to 8%, 1.6% to 7%, 1.8% to 6%, 2% to 5%, 2.2% to 4.8%, 2.4% to 4.6%, 2.6% to 4.4%, 2.8% to 4.2%, 3% to 4%, particularly 3.2% to 3.8%.

When emphasizing the hydrolytic resistance, a molar ratio CaO/(Li₂O+Na₂O+K₂O+MgO+CaO+SrO+BaO) is preferably 0.5 or less, 0.4 or less, 0.3 or less, 0.25 or less, 0.24 or less, 0.23 or less, 0.2 or less, 0.1 or less, 0.05 or less, 0.04 or less, 0.03 or less, 0.025 or less, 0.02 or less, 0.019 or less, 0.018 or less, less than 0.018, 0.015 or less, 0.01 or less, particularly preferably 0.001 or less.

In order to achieve both the hydrolytic resistance and processability, it is preferable to preferentially introduce MgO and CaO that are unlikely to cause precipitation of carbonate or sulfate among the alkaline earth metal oxides. Further, it is preferable to adjust so that the amount of CaO having a high effect of decreasing the viscosity of the glass is relatively large. When emphasizing both the processability and the difficulty in precipitating salts and insoluble foreign matters, it is preferable to increase a value of a molar ratio CaO/(MgO+CaO+SrO+BaO). The lower limit range of the molar ratio CaO/(MgO+CaO+SrO+BaO) is preferably 0.01 or more, 0.03 or more, 0.05 or more, 0.1 or more, 0.2 or more, 0.3 or more, 0.4 or more, 0.5 or more, 0.6 or more, 0.7 or more, 0.8 or more, particularly preferably 0.9 or more.

The content of SrO is preferably 0% to 1%, 0% to 0.9%, 0% to 0.8%, 0% to 0.7%, 0% to 0.6%, 0% to 0.5%, 0% to 0.4%, 0% to 0.3%, 0% to 0.2%, 0% to 0.1%, 0% to 0.01%, 0% to less than 0.01%, particularly preferably 0% to 0.001%. When the content of SrO is too large, carbonate or sulfate is liable to be precipitated, and the hydrolytic resistance is liable to deteriorate.

The content of BaO is preferably 0% to 1%, 0% to 0.9%, 0% to 0.8%, 0% to 0.7%, 0% to 0.6%, 0% to 0.5%, 0% to 0.4%, 0% to 0.3%, 0% to 0.2%, 0% to 0.1%, 0% to 0.01%, 0% to less than 0.01%, particularly preferably 0% to 0.001%. When the content of BaO is too large, carbonate or sulfate is liable to be precipitated, and the hydrolytic resistance is liable to deteriorate.

MgO is an ingredient that cause high solubility of carbonate and sulfate and is unlikely to cause salt precipitation. Meanwhile, Mg ions are liable to react with hydrated silicic acid, which leads to formation of an insoluble magnesium silicate hydrate film. Therefore, a molar ratio MgO/(MgO+CaO+SrO+BaO) is preferably 1 or less, less than 1, 0.9 or less, 0.8 or less, 0.7 or less, 0.6 or less, 0.5 or less, less than 0.5, 0.4 or less, 0.3 or less, 0.2 or less, 0.1 or less, 0.01 or less, particularly preferably 0.001 or less.

From the viewpoint of preventing the formation of an insoluble magnesium silicate hydrate film, a molar ratio MgO/(Li₂O+Na₂O+K₂O+MgO+CaO+SrO+BaO) is preferably 0.5 or less, 0.4 or less, 0.3 or less, 0.2 or less, 0.1 or less, 0.09 or less, 0.08 or less, 0.07 or less, 0.06 or less, less than 0.06, 0.05 or less, 0.04 or less, 0.03 or less, 0.02 or less, 0.01 or less, particularly preferably 0.001 or less.

From the viewpoint of emphasizing the hydrolytic resistance, a molar ratio (MgO+CaO+SrO+BaO)/(Li₂O+Na₂O+K₂O+MgO+CaO+SrO+BaO) is preferably 0.5 or less, 0.4 or less, 0.3 or less, 0.2 or less, 0.1 or less, 0.09 or less, 0.08 or less, 0.07 or less, 0.06 or less, less than 0.06, 0.05 or less, 0.04 or less, 0.03 or less, 0.02 or less, 0.01 or less, particularly preferably 0.001 or less.

The content of MgO+CaO is preferably 0% to 10%, 0% to 5%, 0% to 4%, 0% to 3.7%, 0% to 3%, 0% to 2%, 0% to 1%, 0% to 0.9%, 0% to 0.8%, 0% to 0.7%, 0% to 0.6%, 0% to 0.5%, 0% to 0.4%, 0% to 0.3%, 0% to 0.2%, 0% to 0.1%, 0% to 0.01%, 0% to less than 0.01%, particularly preferably 0% to 0.001%. When the content of MgO+CaO is too large, carbonate or sulfate is liable to be precipitated. “MgO+CaO” refers to the total content of MgO and CaO.

As described above, MgO leads to formation of an insoluble magnesium silicate hydrate film. CaO is an ingredient that is less likely to react with SiO₂ than MgO, and that is less likely to lead to formation of an insoluble film. Therefore, from the viewpoint of enhancing the safety of the pharmaceutical container, a molar ratio MgO/CaO is preferably less than 9.0, 8.0 or less, 6.0 or less, less than 5.0, less than 3.0, 1.0 or less, less than 1.0, 0.9 or less, less than 0.7, less than 0.5, less than 0.4, less than 0.3, less than 0.2, particularly preferably less than 0.1. When the molar ratio MgO/CaO is too large, the hydrolytic resistance is liable to deteriorate.

In order to achieve both the hydrolytic resistance and processability, it is preferable to regulate a molar ratio Li₂O/CaO when emphasizing the content of Li₂O in order to balance the ingredients of Li₂O and CaO. The molar ratio Li₂O/CaO is preferably 100 or less, 90 or less, 80 or less, 70 or less, 60 or less, 50 or less, 40 or less, 30 or less, 20 or less, 10 or less, 9 or less, 8 or less, 7 or less, 6 or less, 5 or less, 4 or less, 3.5 or less, 3.4 or less, 3.3 or less, 3.2 or less, 3.1 or less, 3 or less, 2 or less, 1.8 or less, 1.7 or less, 1.6 or less, particularly preferably 1.5 or less.

In order to achieve both the hydrolytic resistance and processability, it is preferable to regulate the molar ratio CaO/Li₂O when emphasizing the content of CaO in order to balance the ingredients of Li₂O and CaO. The molar ratio CaO/Li₂O is preferably 2.0 or less, 1.5 or less, 1.2 or less, 1.1 or less, 1.0 or less, less than 1.0, 0.9 or less, 0.8 or less, 0.7 or less, 0.6 or less, 0.5 or less, 0.4 or less, 0.3 or less, 0.2 or less, 0.1 or less, particularly preferably 0.001 or less.

The content of SiO₂+Al₂O₃+Li₂O+Na₂O+K₂O+MgO+CaO+SrO+BaO is preferably 90% or more, 93% or more, 95% or more, 96% or more, 97% or more, 98% or more, 98.5% or more, particularly preferably 99% or more. When the content of SiO₂+Al₂O₃+Li₂O+Na₂O+K₂O+MgO+CaO+SrO+BaO is too small, it is difficult to achieve both the hydrolytic resistance and processability.

A molar ratio (Li₂O+Na₂O+K₂O+MgO+CaO+SrO+BaO—Al₂O₃)/(SiO₂+Al₂O₃) is a ratio of the ingredient that cuts the network structure in the glass to the ingredient that forms the network structure in the glass. As described above, the alkali metal oxides and the alkaline earth metal oxides have an effect of cutting the network structure in the glass, but the alkali metal oxides in the same amount as the content of Al₂O₃ are not effective in cutting the network since Al₂O₃ forms the network structure in the glass together with the alkali metal oxide. Further, SiO₂ and Al₂O₃ are ingredients that form the network structure in the glass. Accordingly, as the molar ratio (Li₂O+Na₂O+K₂O+MgO+CaO+SrO+BaO—Al₂O₃)/(SiO₂+Al₂O₃) is smaller, the ingredient that cuts the network structure is smaller with respect to the ingredient that forms the network structure, so that the chemical durability, particularly the hydrolytic resistance, is improved. Therefore, the upper limit range of the molar ratio (Li₂O+Na₂O+K₂O+MgO+CaO+SrO+BaO—Al₂O₃)/(SiO₂+Al₂O₃) is 0.2 or less, preferably 0.19 or less, 0.018 or less, 0.17 or less, 0.16 or less, less than 0.159, 0.158 or less, 0.157 or less, 0.156 or less, less than 0.155, 0.15 or less, 0.14 or less, 0.13 or less, 0.12 or less, particularly preferably 0.11 or less. In particular, when the molar ratio (Li₂O+Na₂O+K₂O+MgO+CaO+SrO+BaO—Al₂O₃)/(SiO₂+Al₂O₃) is 0.156 or less, both the hydrolytic resistance and processability are particularly liable to be achieved. Meanwhile, when the molar ratio (Li₂O+Na₂O+K₂O+MgO+CaO+SrO+BaO—Al₂O₃)/(SiO₂+Al₂O₃) is too small, the viscosity of the glass is liable to increase. Therefore, the lower limit range of the molar ratio (Li₂O+Na₂O+K₂O+MgO+CaO+SrO+BaO—Al₂O₃)/(SiO₂+Al₂O₃) is preferably 0 or more, 0.01 or more, 0.02 or more, 0.03 or more, 0.04 or more, 0.05 or more, 0.06 or more, 0.07 or more, 0.08 or more, 0.09 or more, particularly preferably 0.1 or more.

In addition to the above ingredients, other ingredients may be introduced.

ZrO₂ is an ingredient that enhances alkali resistance. However, when the content of ZrO₂ is too large, the viscosity of the glass increases, and the devitrification resistance is liable to decrease. Therefore, the content of ZrO₂ is preferably 0% to 3%, 0% to 2.5%, 0% to 2%, 0% to 1.5%, 0.1% to 0.8%, particularly preferably 0.2% to 0.6%.

ZnO has an effect of decreasing the viscosity of glass. However, when the content of ZnO is too large, the hydrolytic resistance is adversely affected. Therefore, the content of ZnO is preferably 0% to 4%, 0% to 1%, particularly preferably 0% to 0.01%.

When the glass is desired to be colored, TiO₂ and Fe₂O₃ may be added to the batch raw material. In this case, the total content and individual content of TiO₂ and Fe₂O₃ are preferably 7% or less, 6% or less, more than 0% to 5%, 0.001% to 1%, particularly preferably 0.1% to 0.5%.

TiO₂ and Fe₂O₃ are also ingredients contained as impurities in the SiO₂ raw material, for example. Therefore, TiO₂ and Fe₂O₃ may be contained in the glass even when the glass is not colored. When the glass is not colored, the content of TiO₂ is preferably 0.1% or less, 0.08% or less, 0.05% or less, 0.03% or less, 0.01% or less, particularly preferably 0.005% or less, and the content of Fe₂O₃ is preferably 0.1% or less, 0.08% or less, 0.05% or less, 0.03% or less, 0.01% or less, particularly preferably 0.005% or less.

As a fining agent, one or more kinds of F, Cl, Sb₂O₃, SnO₂, SO₃ and the like may be introduced. The total content and individual content of these fining agents are preferably 5% or less, 1% or less, 0.5% or less, particularly preferably 0.3% or less. Note that, even when Cl is not added as a fining agent, Cl may be contained in the glass as impurities contained in the batch raw material. When the content of Cl is too large, white defects are likely to occur when the glass is subjected to heat processing. Therefore, the content of Cl is preferably 0.1% or less, 0.05% or less, 0.01% or less, 0.005% or less, particularly preferably 0.04% or less.

In order to improve chemical durability, viscosity in high temperature and the like, P₂O₅, Cr₂O₃, PbO, La₂O₃, WO₃, Nb₂O₃, Y₂O₃, and the like may be introduced at 3% or less, 2% or less, 1% or less, less than 1%, or 0.5% or less each.

As impurities, ingredients such as H₂, CO₂, CO, H₂O, He, Ne, Ar, and N₂ may be introduced up to 0.1% each. The amount of noble metal elements such as Pt, Rh, and Au to be mixed is preferably 500 ppm or less, and more preferably 300 ppm or less.

In the glass for a pharmaceutical container of the present invention, the class in a hydrolytic resistance test (acetone washing) according to ISO 720 is preferably at least HGA2, and particularly preferably HGA1.

An elution amount of alkali in terms of Na₂O determined by the hydrolytic resistance test (acetone washing) according to ISO 720 is preferably less than 527 μg/g, 200 μgig or less, 100 μg/g or less, 90 μg/g or less, 80 μg/g or less, 70 μg/g or less, less than 62 μg/g, 60 μg/g or less, 57 μg/g or less, 55 μg/g or less, 53 μg/g or less, particularly preferably 50 μg/g or less. In a case where the elution amount of alkali is too large, the medicament ingredient may be changed in quality due to the alkali component eluted from the glass when the glass is processed into an ampoule or a vial, filled with and stores medicaments.

Further, the alkali resistance in a test according to ISO 695 is preferably at least class 2. Here, the “alkali resistance test according to ISO 695” refers to the following test.

(1) A sample is prepared which has a surface area Acm² (where A is 10 cm² to 15 cm²) and in which the entire surface is mirror-finished. First, as a pretreatment, hydrofluoric acid (40 mass %) and hydrochloric acid (2 mol/L) are mixed at a volume ratio of 1:9 to prepare a solution. The sample is immersed in the solution, followed by stirring with a magnetic stirrer for 10 minutes. The sample is taken out, ultrasonic washing with purified water for 2 minutes is performed three times, and ultrasonic washing with ethanol for 1 minute is performed twice.

(2) Thereafter, the sample is dried in an oven at 110° C. for 1 hour, and is allowed to cool in a desiccator for 30 minutes.

(3) The mass m1 of the sample is measured and recorded to an accuracy of ±0.1 mg.

(4) An sodium hydroxide aqueous solution (1 mol/L) and a sodium carbonate aqueous solution (0.5 mol/L) are mixed at a volume ratio of 1:1 to prepare 800 mL of a solution. The solution is placed in a stainless steel container and boiled by a mantle heater. Next, after the sample suspended by a platinum wire is put thereto and held for 3 hours, the sample is taken out, ultrasonic washing with purified water for 2 minutes is performed three times, and ultrasonic washing with ethanol for 1 minute is performed twice. Thereafter, the sample is dried in an oven at 110° C. for 1 hour, and is allowed to cool in a desiccator for 30 minutes.

(5) The mass m2 of the sample is measured and recorded to an accuracy of ±0.1 mg.

(6) From the masses m1 and m2 (mg) before and after the introduction into the boiling alkaline solution and the surface area A (cm²) of the sample, a mass loss amount per unit area is calculated by the following calculation formula, and the calculated mass loss amount is used as a measurement value of the alkali resistance test.

(Mass loss amount per unit area)=100×(m1−m2)/A

The “alkali resistance in the test according to ISO 695 is class 2” means that the mass loss amount per unit area determined as described above is 175 mg/dm² or less. When the mass loss amount per unit area determined as described above is 75 mg/dm² or less, “alkali resistance in a test according to ISO 695 is class 1”. In the glass for a pharmaceutical container of the present invention, the mass loss amount per unit area is preferably 130 mg/dm² or less, particularly preferably 75 mg/dm² or less.

The delamination often occurs when a glass container is filled with and stores medicaments in which a solution (e.g., citric acid, a phosphate buffer solution) is used that exhibits a behavior such as a strong alkaline solution even when the pH is around neutral. When the mass loss amount per unit area determined by the test according to ISO 695 is more than 175 mg/dm², the delamination is more likely to occur. Therefore, in the glass for a pharmaceutical container of the present invention, the mass loss amount per unit area is preferably 130 mg/dm² or less, particularly preferably 75 mg/dm² or less.

In an acid resistance test according to YBB⋅BR>00342004, the mass loss amount per unit area is preferably 1.5 mg/dm² or less, particularly preferably 0.7 mg/dm² or less. In a case where the mass loss amount is large, the elution amount of the glass component is significantly increased when a pharmaceutical container such as an ampoule or a vial is prepared, then is filled with and stores aqueous-based medicaments, and the aqueous-based medicament ingredient is caused to be changed in quality.

The “acid resistance test according to YBB00342004” refers to the following test.

(1) A sample is prepared which has a surface area Acm² (where A is 100±5 cm²) and in which the entire surface is mirror-finished. First, as a pretreatment, hydrofluoric acid (40 mass %) and hydrochloric acid (2 mol/L) are mixed at a volume ratio of 1:9 to prepare a solution. The sample is immersed in the solution, followed by stirring with a magnetic stirrer for 10 minutes. The sample is taken out, ultrasonic washing with purified water for 2 minutes is performed three times, and ultrasonic washing with ethanol for 1 minute is performed twice.

(2) Thereafter, the sample is dried in an oven at 110° C. for 1 hour, and is allowed to cool in a desiccator for 30 minutes.

(3) The mass m1 of the sample is measured and recorded to an accuracy of ±0.1 mg.

(4) 800 mL of a hydrochloric acid solution (6 mol/L) is prepared. The hydrochloric acid solution is put in a container formed of silica glass and boiled by an electric heater. A sample suspended by a platinum wire is put thereto and held for 6 hours. The sample is taken out, ultrasonic washing with purified water for 2 minutes is performed three times, and ultrasonic washing with ethanol for 1 minute is performed twice. Thereafter, the sample is dried in an oven at 110° C. for 1 hour, and is allowed to cool in a desiccator for 30 minutes.

(5) The mass m2 of the sample is measured and recorded to an accuracy of ±0.1 mg.

(6) From the masses m1 and m2 (mg) before and after the introduction into the boiling acid solution and the surface area A (cm²) of the sample, a half of the mass loss amount per unit area is calculated by the following calculation formula, and is used as a measurement value of the acid resistance test.

(Mass loss amount per unit area=½×100×(m1−m2)/A

In the glass for a pharmaceutical container of the present invention, the working point is preferably 1350° C. or less, 1300° C. or less, 1260° C. or less, particularly preferably 1250° C. or less. When the working point is high, the processing temperature at the time of processing the glass tube into an ampoule or a vial becomes higher, and the volatilization of the alkali component contained in the glass significantly increases. The volatilized alkali component adheres to the inner wall of the glass tube, and the glass tube in this state is processed into a glass container. Such a glass container becomes a cause of changing the medicaments in quality when the glass container is filled with and stores the medicaments. In addition, in the case of glass containing a large amount of boron, the higher the working point is, the higher the volatilization of boron is, which may cause delamination.

The glass for a pharmaceutical container of the present invention can be subjected to chemical strengthening (ion exchanging) to form a compression stress layer on the surface thereof. In the glass for a pharmaceutical container of the present invention, a compression stress value of the compression stress layer formed when the glass for a pharmaceutical container is subjected to chemical strengthening by being immersed in a KNO₃ molten salt at 475° C. for 7 hours is preferably 100 MPa or more, more preferably 200 MPa or more, and particularly preferably 300 MPa or more. Further, a stress depth of the compression stress layer formed when the glass for a pharmaceutical container is subjected to chemical strengthening by being immersed in the KNO₃ molten salt at 475° C. for 7 hours is preferably 10 μm or more, more preferably 20 μm or more, and particularly preferably 30 μm or more.

The compression stress value and the stress depth of the compression stress layer can be measured as follows. First, both surfaces of a sample are mirror-polished, and then the sample is immersed in a KNO₃ molten salt at 475° C. for 7 hours to perform chemical strengthening. Subsequently, the surface of the sample is washed, and the compression stress value and the stress depth are calculated based on the number of interference fringes observed using a surface stress meter (FSM-6000 manufactured by Orihara Seisakusho Co., Ltd.) and an interval between the interference fringes. In the calculation, a refractive index of the sample is 1.50, and a photoelastic constant is 29.5 [(nm/cm)/MPa]. Note that, before and after the chemical strengthening, the glass composition in the glass surface layer is microscopically different, but the glass composition is not substantially different as a whole of the glass.

Next, a method for manufacturing the glass tube for a pharmaceutical container of the present invention will be described by a Danner process.

First, a glass raw material is blended so as to have a predetermined glass composition to prepare a batch. Next, this batch is continuously charged into a melting kiln at 1550° C. to 1700° C. to perform melting and fining. Then, while the obtained molten glass is wound around a rotating refractory, air is blown out from a front end portion of the refractory, and the glass is drawn out in a tubular shape from the front end portion of the refractory.

Subsequently, the drawn tubular glass is cut to a predetermined length to obtain a glass tube. The glass tube thus obtained is used for manufacturing a pharmaceutical container such as a vial or an ampoule.

The manufacturing of the glass tube for a pharmaceutical container of the present invention is not limited to the Danner process. The glass tube for a pharmaceutical container may be manufactured by another method (for example, a Vello process or a down-draw method).

Next, a method for manufacturing the pharmaceutical container of the present invention will be described. Hereinafter, a method of manufacturing a pharmaceutical container by processing a glass tube by a vertical processing method will be described, but this method is an example.

First, after a glass tube is prepared, an end portion on one side of the glass tube is heated by a burner in a state where the glass tube stands vertically, and a shoulder portion and a mouth portion are formed by using a forming tool. Next, a portion of the glass tube above the shoulder portion is heated and fused with a burner. Subsequently, the fused portion is heated and formed with a burner to form a bottom portion, thereby obtaining a pharmaceutical container.

The fused portion on the glass tube side is opened by heating with a burner, and is used for manufacturing the next pharmaceutical container. By repeating such processing, a plurality of pharmaceutical containers can be obtained from the glass tube.

If necessary, a chemical strengthened pharmaceutical container can be obtained by immersing a pharmaceutical container such as an ampoule or a vial in a KNO₃ molten salt and performing ion exchange.

The glass tube for a pharmaceutical container and the pharmaceutical container may have a coating on an inner surface and/or an outer surface thereof. Examples of the coating include inorganic coating such as fluorine, silicon, and a surfactant, and organic coating.

### Example

Hereinafter, the present invention will be described based on examples. The following examples are merely illustrative and do not limit the present invention.

Tables 1 to 6 show examples (sample Nos. 1 to 69) of the present invention. In the tables, “R₂O” means Li₂O+Na₂O+K₂O, “R′O” means MgO+CaO+SrO+BaO, and “N.A.” means unmeasured.

TABLE 1

| [mol %] | No. 1 | No. 2 | No. 3 | No. 4 | No. 5 | No. 6 | No. 7 | No. 8 | No. 9 | No. 10 | No. 11 | No. 12 |
|---|---|---|---|---|---|---|---|---|---|---|---|---|
| SiO₂ | 78.7 | 79.6 | 80.1 | 80.5 | 79.7 | 78.7 | 78.7 | 77.9 | 82.8 | 79.6 | 80.9 | 82.2 |
| Al₂O₃ | 6.8 | 5.9 | 5.4 | 5.0 | 5.0 | 5.0 | 4.5 | 4.5 | 3.8 | 4.9 | 4.6 | 4.3 |
| B₂O₃ | 0.1 | 0.1 | 0.1 | 0.1 | 0.1 | 0.1 | 0.1 | 0.1 | 0.0 | 0.1 | 0.1 | 0.1 |
| Li₂O | 6.1 | 6.1 | 6.1 | 6.1 | 4.8 | 4.8 | 4.8 | 4.8 | 6.1 | 6.1 | 6.1 | 6.1 |
| Na₂O | 4.9 | 4.9 | 4.9 | 4.9 | 3.6 | 4.6 | 4.6 | 4.6 | 3.9 | 5.9 | 4.9 | 3.9 |
| K₂O | 2.7 | 2.7 | 2.7 | 2.7 | 2.7 | 2.7 | 3.2 | 4.0 | 2.7 | 2.7 | 2.7 | 2.7 |
| MgO | 0.0 | 0.0 | 0.0 | 0.0 | 0.0 | 0.0 | 0.0 | 0.0 | 0.0 | 0.0 | 0.0 | 0.0 |
| CaO | 0.0 | 0.0 | 0.0 | 0.0 | 3.4 | 3.4 | 3.4 | 3.4 | 0.0 | 0.0 | 0.0 | 0.0 |
| SrO | 0.0 | 0.0 | 0.0 | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 | 0.0 | 0.0 | 0.0 |
| ZrO₂ | 0.5 | 0.5 | 0.5 | 0.5 | 0.5 | 0.5 | 0.5 | 0.5 | 0.5 | 0.5 | 0.5 | 0.5 |
| SnO₂ | 0.2 | 0.2 | 0.2 | 0.2 | 0.2 | 0.2 | 0.2 | 0.2 | 0.2 | 0.2 | 0.2 | 0.2 |
| Fe₂O₃ | 0.008 | 0.007 | 0.008 | 0.008 | 0.008 | 0.007 | 0.007 | 0.007 | 0.008 | 0.008 | 0.008 | 0.010 |
| TiO₂ | 0.007 | 0.007 | 0.007 | 0.007 | 0.005 | 0.007 | 0.005 | 0.005 | 0.007 | 0.009 | 0.007 | 0.005 |
| Cl | 0.004 | 0.004 | 0.004 | 0.003 | 0.004 | 0.004 | 0.004 | 0.004 | 0.003 | 0.003 | 0.003 | 0.003 |
| SiO₂ + Al₂O₃ + R₂O + | 99.2 | 99.2 | 99.2 | 99.2 | 99.2 | 99.2 | 99.2 | 99.2 | 99.3 | 99.2 | 99.2 | 99.2 |
| R′O | | | | | | | | | | | | |
| R₂O | 13.7 | 13.7 | 13.7 | 13.7 | 11.1 | 12.1 | 12.6 | 13.4 | 12.7 | 14.7 | 13.7 | 12.7 |
| R′O | 0.0 | 0.0 | 0.0 | 0.0 | 3.4 | 3.4 | 3.4 | 3.4 | 0.0 | 0.0 | 0.0 | 0.0 |
| R₂O/Al₂O₃ | 2.015 | 2.322 | 2.537 | 2.740 | 2.220 | 2.420 | 2.800 | 2.978 | 3.342 | 3.000 | 2.978 | 2.953 |
| Li₂O/R₂O | 0.445 | 0.445 | 0.445 | 0.445 | 0.432 | 0.397 | 0.381 | 0.358 | 0.480 | 0.415 | 0.445 | 0.480 |
| Li₂O/CaO | — | — | — | — | 1.412 | 1.412 | 1.412 | 1.412 | — | — | — | — |
| CaO/R′O | — | — | — | — | 1.000 | 1.000 | 1.000 | 1.000 | — | — | — | — |
| CaO/(R₂O + R′O) | 0.000 | 0.000 | 0.000 | 0.000 | 0.234 | 0.219 | 0.213 | 0.202 | 0.000 | 0.000 | 0.000 | 0.000 |
| R′O/(R₂O + R′O) | 0.000 | 0.000 | 0.000 | 0.000 | 0.234 | 0.219 | 0.213 | 0.202 | 0.000 | 0.000 | 0.000 | 0.000 |
| SiO₂/Al₂O₃ | 11.574 | 13.492 | 14.833 | 16.100 | 15.940 | 15.740 | 17.489 | 17.311 | 21.789 | 16.245 | 17.587 | 19.116 |
| (R₂O + R′O − Al₂O₃)/ | 0.081 | 0.091 | 0.097 | 0.102 | 0.112 | 0.125 | 0.138 | 0.149 | 0.103 | 0.116 | 0.106 | 0.097 |
| (SiO₂ + Al₂O₃) | | | | | | | | | | | | |
| Ps [° C.] | N.A. | N.A. | N.A. | N.A. | N.A. | N.A. | N.A. | N.A. | N.A. | N.A. | N.A. | N.A. |
| Ta [° C.] | N.A. | N.A. | N.A. | N.A. | N.A. | N.A. | N.A. | N.A. | N.A. | N.A. | N.A. | N.A. |
| Ts [° C.] | N.A. | N.A. | N.A. | N.A. | N.A. | N.A. | N.A. | N.A. | N.A. | N.A. | N.A. | N.A. |
| Working point (10^{4.0} | N.A. | N.A. | N.A. | N.A. | N.A. | N.A. | N.A. | N.A. | N.A. | N.A. | N.A. | N.A. |
| dPa · s) [° C.] | | | | | | | | | | | | |
| 10^{3.0} dPa · s [° C.] | N.A. | N.A. | N.A. | N.A. | N.A. | N.A. | N.A. | N.A. | N.A. | N.A. | N.A. | N.A. |
| Hydrolytic resistance test | 33.5 | 37.5 | 39.4 | 45.0 | 45.3 | 56.1 | 71.3 | 92.7 | 49.0 | 61.1 | 49.6 | 42.5 |
| [μg/g] | | | | | | | | | | | | |
| Acid resistance test | N.A. | N.A. | N.A. | N.A. | N.A. | N.A. | N.A. | N.A. | N.A. | N.A. | N.A. | N.A. |
| (DIN12116) [mg/dm²] | | | | | | | | | | | | |
| Alkali resistance test | N.A. | N.A. | N.A. | N.A. | N.A. | N.A. | N.A. | N.A. | N.A. | N.A. | N.A. | N.A. |
| (ISO695) [mg/dm²] | | | | | | | | | | | | |
| Linear thermal expansion | N.A. | N.A. | N.A. | N.A. | N.A. | N.A. | N.A. | N.A. | N.A. | N.A. | N.A. | N.A. |
| coefficient (20 to 300° C.) | | | | | | | | | | | | |
| Liquidus temperature [° C.] | N.A. | N.A. | N.A. | N.A. | N.A. | N.A. | N.A. | N.A. | N.A. | N.A. | N.A. | N.A. |
| log η at TL [dPa · s] | N.A. | N.A. | N.A. | N.A. | N.A. | N.A. | N.A. | N.A. | N.A. | N.A. | N.A. | N.A. |

TABLE 2

| [mol %] | No. 13 | No. 14 | No. 15 | No. 16 | No. 17 | No. 18 | No. 19 |
|---|---|---|---|---|---|---|---|
| SiO₂ | 72.8 | 74.8 | 77.3 | 77.8 | 77.1 | 79.4 | 77.6 |
| Al₂O₃ | 12.5 | 11.5 | 9.0 | 8.5 | 6.0 | 6.0 | 6.0 |
| B₂O₃ | 0.1 | 0.1 | 0.1 | 0.1 | 0.1 | 0.1 | 0.1 |
| Li₂O | 6.1 | 6.1 | 6.1 | 6.1 | 6.1 | 6.1 | 6.2 |
| Na₂O | 5.1 | 4.1 | 4.1 | 4.1 | 5.9 | 5.9 | 5.8 |
| K₂O | 2.7 | 2.7 | 2.7 | 2.7 | 1.9 | 1.9 | 1.5 |
| MgO | 0.0 | 0.0 | 0.0 | 0.0 | 0.0 | 0.0 | 0.0 |
| CaO | 0.0 | 0.0 | 0.0 | 0.0 | 2.4 | 0.0 | 2.3 |
| SrO | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 |
| ZrO₂ | 0.5 | 0.5 | 0.5 | 0.5 | 0.5 | 0.5 | 0.5 |
| SnO₂ | 0.2 | 0.2 | 0.2 | 0.2 | 0.0 | 0.1 | 0.0 |
| Fe₂O₃ | 0.007 | 0.007 | 0.007 | 0.007 | N.A. | N.A. | 0.005 |
| TiO₂ | 0.007 | 0.007 | 0.007 | 0.007 | N.A. | N.A. | 0.010 |
| Cl | 0.004 | 0.004 | 0.004 | 0.004 | N.A. | N.A. | 0.014 |
| SiO₂ + Al₂O₃ + R₂O + | 99.2 | 99.2 | 99.2 | 99.2 | 99.4 | 99.3 | 99.4 |
| R′O | | | | | | | |
| R₂O | 13.9 | 12.9 | 12.9 | 12.9 | 13.9 | 13.9 | 13.5 |
| R′O | 0.0 | 0.0 | 0.0 | 0.0 | 2.4 | 0.0 | 2.3 |
| R₂O/Al₂O₃ | 1.112 | 1.122 | 1.433 | 1.518 | 2.317 | 2.317 | 2.250 |
| Li₂O/R₂O | 0.439 | 0.473 | 0.473 | 0.473 | 0.439 | 0.439 | 0.459 |
| Li₂O/CaO | — | — | — | — | 2.542 | — | 2.696 |
| CaO/R′O | — | — | — | — | 1.000 | — | 1.000 |
| CaO/(R₂O + R′O) | 0.000 | 0.000 | 0.000 | 0.000 | 0.147 | 0.000 | 0.146 |
| R′O/(R₂O + R′O) | 0.000 | 0.000 | 0.000 | 0.000 | 0.147 | 0.000 | 0.146 |
| SiO₂/Al₂O₃ | 5.824 | 6.504 | 8.589 | 9.153 | 12.850 | 13.233 | 12.933 |
| (R₂O + R′O − Al₂O₃)/ | 0.016 | 0.016 | 0.045 | 0.051 | 0.124 | 0.093 | 0.117 |
| (SiO₂ + Al₂O₃) | | | | | | | |
| Ps [° C.] | N.A. | N.A. | N.A. | N.A. | N.A. | N.A. | 479 |
| Ta [° C.] | N.A. | N.A. | N.A. | N.A. | N.A. | N.A. | 524 |
| Ts [° C.] | N.A. | N.A. | N.A. | N.A. | N.A. | N.A. | 758 |
| Working point (10^{4.0} | N.A. | N.A. | N.A. | N.A. | 1176 | 1219 | 1178 |
| dPa · s) [° C.] | | | | | | | |
| 10^{3.0} dPa · s [° C.] | N.A. | N.A. | N.A. | N.A. | 1408 | 1464 | 1411 |
| Hydrolytic resistance test | 40.6 | 36.0 | 33.8 | 31.3 | 58.9 | 39.4 | 55.2 |
| [μg/g] | | | | | | | |
| Acid resistance test | N.A. | N.A. | N.A. | N.A. | N.A. | N.A. | N.A. |
| (DIN12116) [mg/dm²] | | | | | | | |
| Alkali resistance test | N.A. | N.A. | N.A. | N.A. | N.A. | N.A. | N.A. |
| (ISO695)[mg/dm²] | | | | | | | |
| Linear thermal expansion | N.A. | N.A. | N.A. | N.A. | N.A. | N.A. | N.A. |
| coefficient (20 to 300° C.) | | | | | | | |
| Liquidus temperature [° C.] | N.A. | N.A. | N.A. | N.A. | N.A. | N.A. | N.A. |
| log η at TL [dPa · s] | N.A. | N.A. | N.A. | N.A. | N.A. | N.A. | N.A. |

| [mol %] | No. 20 | No. 21 | No. 22 | No. 23 | No. 24 |
|---|---|---|---|---|---|
| SiO₂ | 77.6 | 77.3 | 77.3 | 77.8 | 76.8 |
| Al₂O₃ | 6.0 | 6.2 | 6.1 | 6.0 | 6.0 |
| B₂O₃ | 0.1 | 0.1 | 0.1 | 0.1 | 0.1 |
| Li₂O | 6.1 | 6.3 | 6.1 | 6.1 | 6.1 |
| Na₂O | 5.9 | 5.8 | 4.9 | 5.8 | 5.9 |
| K₂O | 1.5 | 1.5 | 1.9 | 0.0 | 0.0 |
| MgO | 0.0 | 0.0 | 0.0 | 0.0 | 1.5 |
| CaO | 2.3 | 2.3 | 3.1 | 3.6 | 3.0 |
| SrO | 0.0 | 0.0 | 0.0 | 0.0 | 0.0 |
| BaO | 0.0 | 0.0 | 0.0 | 0.0 | 0.0 |
| ZrO₂ | 0.5 | 0.5 | 0.5 | 0.5 | 0.5 |
| SnO₂ | 0.0 | 0.0 | 0.0 | 0.1 | 0.1 |
| Fe₂O₃ | 0.005 | 0.005 | 0.005 | 0.005 | 0.006 |
| TiO₂ | 0.010 | 0.010 | 0.010 | 0.010 | 0.010 |
| Cl | 0.016 | 0.016 | 0.014 | 0.014 | 0.016 |
| SiO₂ + Al₂O₃ + R₂O + | 99.4 | 99.4 | 99.4 | 99.3 | 99.3 |
| R′O | | | | | |
| R₂O | 13.5 | 13.6 | 12.9 | 11.9 | 12.0 |
| R′O | 2.3 | 2.3 | 3.1 | 3.6 | 4.5 |
| R₂O/Al₂O₃ | 2.250 | 2.194 | 2.115 | 1.983 | 2.000 |
| Li₂O/R₂O | 0.452 | 0.463 | 0.473 | 0.513 | 0.508 |
| Li₂O/CaO | 2.652 | 2.739 | 1.968 | 1.694 | 2.033 |
| CaO/R′O | 1.000 | 1.000 | 1.000 | 1.000 | 1.000 |
| CaO/(R₂O + R′O) | 0.146 | 0.145 | 0.194 | 0.232 | 0.182 |
| R′O/(R₂O + R′O) | 0.146 | 0.145 | 0.194 | 0.232 | 0.273 |
| SiO₂/Al₂O₃ | 12.933 | 12.468 | 12.672 | 12.967 | 12.800 |
| (R₂O + R′O − Al₂O₃)/ | 0.117 | 0.116 | 0.119 | 0.113 | 0.127 |
| (SiO₂ + Al₂O₃) | | | | | |
| Ps [° C.] | 479 | 479 | 487 | 499 | 494 |
| Ta [° C.] | 523 | 524 | 532 | 544 | 539 |
| Ts [° C.] | 758 | 758 | 767 | 779 | 777 |
| Working point (10^{4.0} | 1180 | 1178 | 1186 | 1198 | 1197 |
| dPa · s) [° C.] | | | | | |
| 10^{3.0} dPa · s [° C.] | 1411 | 1410 | 1418 | 1428 | 1422 |
| Hydrolytic resistance test | 57.0 | 54.9 | 54.7 | 53.1 | 55.2 |
| [μg/g] | | | | | |
| Acid resistance test | N.A. | N.A. | N.A. | N.A. | N.A. |
| (DIN12116) [mg/dm²] | | | | | |
| Alkali resistance test | N.A. | N.A. | N.A. | N.A. | N.A. |
| (ISO695)[mg/dm²] | | | | | |
| Linear thermal expansion | N.A. | N.A. | N.A. | N.A. | N.A. |
| coefficient (20 to 300° C.) | | | | | |
| Liquidus temperature [° C.] | N.A. | N.A. | N.A. | N.A. | N.A. |
| log η at TL [dPa · s] | N.A. | N.A. | N.A. | N.A. | N.A. |

TABLE 3

| [mol %] | No. 25 | No. 26 | No. 27 | No. 28 | No. 29 | No. 30 | No. 31 |
|---|---|---|---|---|---|---|---|
| SiO₂ | 75.8 | 77.3 | 78.8 | 75.3 | 75.9 | 76.4 | 75.0 |
| Al₂O₃ | 7.0 | 5.5 | 4.0 | 6.5 | 9.1 | 8.6 | 9.1 |
| B₂O₃ | 0.1 | 0.1 | 0.1 | 0.1 | 0.1 | 0.1 | 0.1 |
| Li₂O | 6.1 | 6.1 | 6.1 | 6.1 | 6.1 | 6.1 | 6.1 |
| Na₂O | 5.9 | 5.9 | 5.9 | 5.8 | 5.8 | 5.8 | 5.8 |
| K₂O | 1.9 | 1.9 | 1.9 | 1.9 | 2.5 | 2.5 | 3.4 |
| MgO | 0.0 | 0.0 | 0.0 | 0.0 | 0.0 | 0.0 | 0.0 |
| CaO | 2.6 | 2.6 | 2.6 | 3.7 | 0.0 | 0.0 | 0.0 |
| SrO | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 |
| ZrO₂ | 0.5 | 0.5 | 0.5 | 0.5 | 0.5 | 0.5 | 0.5 |
| SnO₂ | 0.1 | 0.1 | 0.1 | 0.1 | 0.0 | 0.0 | 0.0 |
| Fe₂O₃ | N.A. | N.A. | N.A. | 0.005 | 0.004 | 0.004 | 0.004 |
| TiO₂ | N.A. | N.A. | N.A. | 0.011 | 0.011 | 0.011 | 0.010 |
| Cl | N.A. | N.A. | N.A. | 0.012 | 0.020 | 0.020 | 0.018 |
| SiO₂ + Al₂O₃ + R₂O + | 99.3 | 99.3 | 99.3 | 99.3 | 99.4 | 99.4 | 99.4 |
| R′O | | | | | | | |
| R₂O | 13.9 | 13.9 | 13.9 | 13.8 | 14.4 | 14.4 | 15.3 |
| R′O | 2.6 | 2.6 | 2.6 | 3.7 | 0.0 | 0.0 | 0.0 |
| R₂O/Al₂O₃ | 1.986 | 2.527 | 3.475 | 2.123 | 1.582 | 1.674 | 1.681 |
| Li₂O/R₂O | 0.439 | 0.439 | 0.439 | 0.442 | 0.424 | 0.424 | 0.399 |
| Li₂O/CaO | 2.346 | 2.346 | 2.346 | 1.649 | — | — | — |
| CaO/R′O | 1.000 | 1.000 | 1.000 | 1.000 | — | — | — |
| CaO/(R₂O + R′O) | 0.158 | 0.158 | 0.158 | 0.211 | 0.000 | 0.000 | 0.000 |
| R′O/(R₂O + R′O) | 0.158 | 0.158 | 0.158 | 0.211 | 0.000 | 0.000 | 0.000 |
| SiO₂/Al₂O₃ | 10.829 | 14.055 | 19.700 | 11.585 | 8.341 | 8.884 | 8.242 |
| (R₂O + R′O − Al₂O₃)/ | 0.115 | 0.133 | 0.151 | 0.134 | 0.062 | 0.068 | 0.074 |
| (SiO₂ + Al₂O₃) | | | | | | | |
| Ps [° C.] | N.A. | N.A. | N.A. | 485 | 496 | 490 | 485 |
| Ta [° C.] | N.A. | N.A. | N.A. | 528 | 545 | 538 | 533 |
| Ts [° C.] | N.A. | N.A. | N.A. | 753 | 806 | 795 | 784 |
| Working point (10^{4.0} | N.A. | N.A. | N.A. | 1159 | 1272 | 1259 | 1243 |
| dPa · s) [° C.] | | | | | | | |
| 10^{3.0} dPa · s [° C.] | N.A. | N.A. | N.A. | 1381 | 1521 | 1508 | 1490 |
| Hydrolytic resistance test | 57.8 | 69.8 | 102.9 | 63.9 | 36.9 | 35.3 | 37.8 |
| [μg/g] | | | | | | | |
| Acid resistance test | N.A. | N.A. | N.A. | N.A. | N.A. | N.A. | N.A. |
| (DIN12116) [mg/dm²] | | | | | | | |
| Alkali resistance test | N.A. | N.A. | N.A. | 47 | N.A. | 55 | N.A. |
| (ISO695)[mg/dm²] | | | | | | | |
| Linear thermal expansion | N.A. | N.A. | N.A. | 72.2 | 70.6 | 70.9 | 75.6 |
| coefficient (20 to 300° C.) | | | | | | | |
| Liquidus temperature [° C.] | N.A. | N.A. | N.A. | N.A. | N.A. | N.A. | N.A. |
| log η at TL [dPa · s] | N.A. | N.A. | N.A. | 5.5 | 6.8 | 6.9 | N.A. |

| [mol %] | No. 32 | No. 33 | No. 34 | No. 35 | No. 36 |
|---|---|---|---|---|---|
| SiO₂ | 75.6 | 76.0 | 75.5 | 74.8 | 76.0 |
| Al₂O₃ | 8.5 | 8.5 | 8.5 | 8.6 | 8.7 |
| B₂O₃ | 0.1 | 0.1 | 0.1 | 0.1 | 0.1 |
| Li₂O | 6.1 | 6.1 | 6.1 | 6.1 | 6.1 |
| Na₂O | 5.8 | 5.8 | 5.8 | 5.8 | 5.8 |
| K₂O | 3.4 | 2.5 | 2.5 | 2.5 | 2.7 |
| MgO | 0.0 | 0.0 | 0.0 | 0.0 | 0.0 |
| CaO | 0.0 | 0.0 | 0.0 | 0.0 | 0.0 |
| SrO | 0.0 | 0.0 | 0.0 | 0.0 | 0.0 |
| BaO | 0.0 | 0.0 | 0.0 | 0.0 | 0.0 |
| ZrO₂ | 0.5 | 1.0 | 1.5 | 2.0 | 0.5 |
| SnO₂ | 0.0 | 0.0 | 0.0 | 0.1 | 0.1 |
| Fe₂O₃ | 0.004 | 0.004 | 0.004 | 0.004 | 0.005 |
| TiO₂ | 0.011 | 0.012 | 0.014 | 0.015 | 0.011 |
| Cl | 0.020 | 0.020 | 0.020 | 0.020 | 0.020 |
| SiO₂ + Al₂O₃ + R₂O + | 99.4 | 98.9 | 98.4 | 97.8 | 99.3 |
| R′O | | | | | |
| R₂O | 15.3 | 14.4 | 14.4 | 14.4 | 14.6 |
| R′O | 0.0 | 0.0 | 0.0 | 0.0 | 0.0 |
| R₂O/Al₂O₃ | 1.800 | 1.694 | 1.694 | 1.674 | 1.678 |
| Li₂O/R₂O | 0.399 | 0.424 | 0.424 | 0.424 | 0.418 |
| Li₂O/CaO | — | — | — | — | — |
| CaO/R′O | — | — | — | — | — |
| CaO/(R₂O + R′O) | 0.000 | 0.000 | 0.000 | 0.000 | 0.000 |
| R′O/(R₂O + R′O) | 0.000 | 0.000 | 0.000 | 0.000 | 0.000 |
| SiO₂/Al₂O₃ | 8.894 | 8.941 | 8.882 | 8.698 | 8.736 |
| (R₂O + R′O − Al₂O₃)/ | 0.081 | 0.070 | 0.070 | 0.070 | 0.070 |
| (SiO₂ + Al₂O₃) | | | | | |
| Ps [° C.] | 481 | 500 | 511 | 522 | 488 |
| Ta [° C.] | 533 | 549 | 560 | 572 | 536 |
| Ts [° C.] | 777 | 808 | 822 | 836 | 792 |
| Working point (10^{4.0} | 1230 | 1267 | 1269 | 1276 | 1253 |
| dPa · s) [° C.] | | | | | |
| 10^{3.0} dPa · s [° C.] | 1474 | 1510 | 1506 | 1506 | 1502 |
| Hydrolytic resistance test | 39.1 | 37.8 | 40.0 | 41.9 | 37.5 |
| [μg/g] | | | | | |
| Acid resistance test | N.A. | N.A. | N.A. | N.A. | N.A. |
| (DIN12116) [mg/dm²] | | | | | |
| Alkali resistance test | N.A. | 42 | 37 | 35 | 49 |
| (ISO695)[mg/dm²] | | | | | |
| Linear thermal expansion | 75.4 | 70.4 | 70.2 | 70.0 | 72.0 |
| coefficient (20 to 300° C.) | | | | | |
| Liquidus temperature [° C.] | N.A. | N.A. | N.A. | N.A. | 804 |
| log η at TL [dPa · s] | N.A. | 7.4 | 7.1 | 7.3 | 7.5 |

TABLE 4

| [mol %] | No. 37 | No. 38 | No. 39 | No. 40 | No. 41 | No. 42 |
|---|---|---|---|---|---|---|
| SiO₂ | 73.9 | 73.9 | 73.9 | 75.9 | 75.9 | 77.9 |
| Al₂O₃ | 7.2 | 7.2 | 7.2 | 7.2 | 7.2 | 7.2 |
| B₂O₃ | 0.1 | 0.1 | 0.1 | 0.1 | 0.1 | 0.1 |
| Li₂O | 8.1 | 6.1 | 4.1 | 6.1 | 4.1 | 6.1 |
| Na₂O | 3.8 | 5.8 | 7.8 | 3.8 | 5.8 | 1.8 |
| K₂O | 2.7 | 2.7 | 2.7 | 2.7 | 2.7 | 2.7 |
| MgO | 0.0 | 0.0 | 0.0 | 0.0 | 0.0 | 0.0 |
| CaO | 3.7 | 3.7 | 3.7 | 3.7 | 3.7 | 3.7 |
| SrO | 0.0 | 0.0 | 0.0 | 0.0 | 0.0 | 0.0 |
| BaO | 0.0 | 0.0 | 0.0 | 0.0 | 0.0 | 0.0 |
| ZrO₂ | 0.5 | 0.5 | 0.5 | 0.5 | 0.5 | 0.5 |
| SnO₂ | 0.0 | 0.0 | 0.0 | 0.0 | 0.0 | 0.0 |
| Fe₂O₃ | 0.005 | 0.005 | 0.005 | 0.005 | 0.006 | 0.006 |
| TiO₂ | 0.010 | 0.010 | 0.010 | 0.010 | 0.011 | 0.011 |
| Cl | 0.014 | 0.019 | 0.025 | 0.014 | 0.018 | 0.007 |
| SiO₂ + Al₂O₃ + R₂O + | 99.4 | 99.4 | 99.4 | 99.4 | 99.4 | 99.4 |
| R′O | | | | | | |
| R₂O | 14.6 | 14.6 | 14.6 | 12.6 | 12.6 | 10.6 |
| R′O | 3.7 | 3.7 | 3.7 | 3.7 | 3.7 | 3.7 |
| R₂O/Al₂O₃ | 2.028 | 2.028 | 2.028 | 1.750 | 1.750 | 1.472 |
| Li₂O/R₂O | 0.555 | 0.418 | 0.281 | 0.484 | 0.325 | 0.575 |
| Li₂O/CaO | 2.189 | 1.649 | 1.108 | 1.649 | 1.108 | 1.649 |
| CaO/R′O | 1.000 | 1.000 | 1.000 | 1.000 | 1.000 | 1.000 |
| CaO/(R₂O + R′O) | 0.202 | 0.202 | 0.202 | 0.227 | 0.227 | 0.259 |
| R′O/(R₂O + R′O) | 0.202 | 0.202 | 0.202 | 0.227 | 0.227 | 0.259 |
| SiO₂/Al₂O₃ | 10.264 | 10.264 | 10.264 | 10.542 | 10.542 | 10.819 |
| (R₂O + R′O − Al₂O₃)/ | 0.137 | 0.137 | 0.137 | 0.110 | 0.110 | 0.083 |
| (SiO₂ + Al₂O₃) | | | | | | |
| Ps [° C.] | 480 | 483 | 489 | 501 | 508 | 528 |
| Ta [° C.] | 523 | 526 | 533 | 547 | 553 | 576 |
| Ts [° C.] | 744 | 748 | 757 | 786 | 796 | 833 |
| Working point (10^{4.0} | 1141 | 1153 | 1166 | 1211 | 1225 | 1283 |
| dPa · s) [° C.] | | | | | | |
| 10^{3.0} dPa · s [° C.] | 1361 | 1374 | 1390 | 1442 | 1458 | 1522 |
| Hydrolytic resistance test | 62.0 | 63.9 | 68.8 | 43.4 | 47.7 | 32.6 |
| Acid resistance test | N.A. | N.A. | N.A. | N.A. | N.A. | N.A. |
| (DIN12116) [mg/dm²] | | | | | | |
| Alkali resistance test | N.A. | N.A. | N.A. | N.A. | N.A. | N.A. |
| (ISO695) [mg/dm²] | | | | | | |
| Linear thermal expansion | 72.4 | 76.1 | 79.3 | 67.7 | 71.6 | 58.0 |
| coefficient (20 to 300° C.) | | | | | | |
| Liquidus temperature [° C.] | 919 | 914 | 925 | 964 | 982 | 982 |
| log η at TL [dPa · s] | 5.6 | 5.7 | 5.7 | 5.7 | 5.6 | 6.0 |
| [mol %] | No. 43 | No. 44 | No. 45 | No. 46 | No. 47 | No. 48 |
| SiO₂ | 77.8 | 77.9 | 76.9 | 76.8 | 76.9 | 76.8 |
| Al₂O₃ | 7.2 | 7.2 | 7.2 | 7.2 | 7.2 | 7.3 |
| B₂O₃ | 0.1 | 0.1 | 0.1 | 0.1 | 0.1 | 0.1 |
| Li₂O | 4.1 | 2.1 | 3.1 | 4.1 | 4.6 | 5.1 |
| Na₂O | 3.8 | 5.8 | 5.7 | 4.8 | 4.3 | 3.8 |
| K₂O | 2.7 | 2.7 | 2.7 | 2.7 | 2.7 | 2.7 |
| MgO | 0.0 | 0.0 | 0.0 | 0.0 | 0.0 | 0.0 |
| CaO | 3.7 | 3.6 | 3.7 | 3.7 | 3.7 | 3.7 |
| SrO | 0.0 | 0.0 | 0.0 | 0.0 | 0.0 | 0.0 |
| BaO | 0.0 | 0.0 | 0.0 | 0.0 | 0.0 | 0.0 |
| ZrO₂ | 0.5 | 0.5 | 0.5 | 0.5 | 0.5 | 0.5 |
| SnO₂ | 0.1 | 0.1 | 0.1 | 0.1 | 0.0 | 0.0 |
| Fe₂O₃ | 0.006 | 0.006 | 0.006 | 0.006 | 0.006 | 0.006 |
| TiO₂ | 0.010 | 0.011 | 0.011 | 0.011 | 0.011 | 0.011 |
| Cl | 0.013 | 0.018 | 0.018 | 0.016 | 0.016 | 0.014 |
| SiO₂ + Al₂O₃ + R₂O + | 99.3 | 99.3 | 99.3 | 99.3 | 99.4 | 99.4 |
| R′O | | | | | | |
| R₂O | 10.6 | 10.6 | 11.5 | 11.6 | 11.6 | 11.6 |
| R′O | 3.7 | 3.6 | 3.7 | 3.7 | 3.7 | 3.7 |
| R₂O/Al₂O₃ | 1.472 | 1.472 | 1.597 | 1.611 | 1.611 | 1.589 |
| Li₂O/R₂O | 0.387 | 0.198 | 0.270 | 0.353 | 0.397 | 0.440 |
| Li₂O/CaO | 1.108 | 0.583 | 0.838 | 1.108 | 1.243 | 1.378 |
| CaO/R′O | 1.000 | 1.000 | 1.000 | 1.000 | 1.000 | 1.000 |
| CaO/(R₂O + R′O) | 0.259 | 0.254 | 0.243 | 0.242 | 0.242 | 0.242 |
| R′O/(R₂O + R′O) | 0.259 | 0.254 | 0.243 | 0.242 | 0.242 | 0.242 |
| SiO₂/Al₂O₃ | 10.806 | 10.819 | 10.681 | 10.667 | 10.681 | 10.521 |
| (R₂O + R′O − Al₂O₃)/ | 0.084 | 0.082 | 0.095 | 0.096 | 0.096 | 0.095 |
| (SiO₂ + Al₂O₃) | | | | | | |
| Ps [° C.] | 533 | 546 | 524 | 518 | 517 | 515 |
| Ta [° C.] | 583 | 597 | 572 | 566 | 564 | 562 |
| Ts [° C.] | 845 | 863 | 828 | 820 | 817 | 814 |
| Working point (10^{4.0} | 1300 | 1321 | 1273 | 1264 | 1260 | 1258 |
| dPa · s) [° C.] | | | | | | |
| 10^{3.0} dPa · s [° C.] | 1541 | 1563 | 1511 | 1504 | 1498 | 1494 |
| Hydrolytic resistance test | 31.3 | 35.3 | 41.2 | 41.2 | 41.2 | 41.5 |
| Acid resistance test | N.A. | N.A. | N.A. | N.A. | N.A. | N.A. |
| (DIN12116) [mg/dm²] | | | | | | |
| Alkali resistance test | N.A. | N.A. | N.A. | N.A. | N.A. | N.A. |
| (ISO695) [mg/dm²] | | | | | | |
| Linear thermal expansion | 62.6 | 66.6 | 68.9 | 67.0 | 66.1 | 65.0 |
| coefficient (20 to 300° C.) | | | | | | |
| Liquidus temperature [° C.] | 1025 | 1046 | 1020 | 999 | 1017 | 995 |
| log η at TL [dPa · s] | 5.8 | 5.7 | 5.6 | 5.7 | 5.5 | 5.7 |

TABLE 5

| [mol %] | No. 49 | No. 50 | No. 51 | No. 52 | No. 53 | No. 54 | No. 55 |
|---|---|---|---|---|---|---|---|
| SlO₂ | 76.8 | 76.7 | 75.9 | 75.7 | 77.0 | 78.5 | 80.0 |
| Al₂O₃ | 7.2 | 7.3 | 7.2 | 7.3 | 6.0 | 5.5 | 5.0 |
| B₂O₃ | 0.1 | 0.1 | 0.1 | 0.1 | 0.1 | 0.1 | 0.1 |
| Li₂O | 6.1 | 7.1 | 5.1 | 7.1 | 8.1 | 7.1 | 6.1 |
| Na₂O | 2.9 | 1.9 | 4.8 | 2.9 | 1.9 | 1.9 | 1.9 |
| K₂O | 2.7 | 2.7 | 2.7 | 2.7 | 2.7 | 2.7 | 2.7 |
| MgO | 0.0 | 0.0 | 0.0 | 0.0 | 0.0 | 0.0 | 0.0 |
| CaO | 3.7 | 3.7 | 3.7 | 3.7 | 3.6 | 3.6 | 3.6 |
| SrO | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 |
| ZrO₂ | 0.5 | 0.5 | 0.5 | 0.5 | 0.5 | 0.5 | 0.5 |
| SnO₂ | 0.0 | 0.0 | 0.0 | 0.0 | 0.1 | 0.1 | 0.1 |
| Fe₂O₃ | 0.005 | 0.005 | 0.005 | 0.005 | N.A. | N.A. | N.A. |
| TiO₂ | 0.010 | 0.010 | 0.010 | 0.010 | N.A. | N.A. | N.A. |
| Cl | 0.011 | 0.009 | 0.016 | 0.011 | N.A. | N.A. | N.A. |
| SiO₂ + Al₂O₃ + R₂O + | 99.4 | 99.4 | 99.4 | 99.4 | 99.3 | 99.3 | 99.3 |
| R′O | | | | | | | |
| R₂O | 11.7 | 11.7 | 12.6 | 12.7 | 12.7 | 11.7 | 10.7 |
| R′O | 3.7 | 3.7 | 3.7 | 3.7 | 3.6 | 3.6 | 3.6 |
| R₂O/Al₂O₃ | 1.625 | 1.603 | 1.750 | 1.740 | 2.117 | 2.127 | 2.140 |
| Li₂O/R₂O | 0.521 | 0.607 | 0.405 | 0.559 | 0.638 | 0.607 | 0.570 |
| Li₂O/CaO | 1.649 | 1.919 | 1.378 | 1.919 | 2.250 | 1.972 | 1.694 |
| CaO/R′O | 1.000 | 1.000 | 1.000 | 1.000 | 1.000 | 1.000 | 1.000 |
| CaO/(R₂O + R′O) | 0.240 | 0.240 | 0.227 | 0.226 | 0.221 | 0.235 | 0.252 |
| R′O/(R₂O + R′O) | 0.240 | 0.240 | 0.227 | 0.226 | 0.221 | 0.235 | 0.252 |
| SiO₂/Al₂O₃ | 10.667 | 10.507 | 10.542 | 10.370 | 12.833 | 14.273 | 16.000 |
| (R₂O + R′O − Al₂O₃)/ | 0.098 | 0.096 | 0.110 | 0.110 | 0.124 | 0.117 | 0.109 |
| (SiO₂ + Al₂O₃) | | | | | | | |
| Ps [° C.] | 513 | 512 | 503 | 500 | N.A. | N.A. | N.A. |
| Ta [° C.] | 560 | 559 | 549 | 545 | N.A. | N.A. | N.A. |
| Ts [° C.] | 810 | 807 | 790 | 784 | N.A. | N.A. | N.A. |
| Working point (10^{4.0} | 1248 | 1241 | 1223 | 1207 | N.A. | N.A. | 1258 |
| dPa · s) [° C.] | | | | | | | |
| 10^{3.0} dPa · s [° C.] | 1484 | 1476 | 1455 | 1437 | N.A. | N.A. | 1495 |
| Hydrolytic resistance test | 40.6 | 40.7 | 47.1 | 45.0 | 47.1 | 43.4 | 38.4 |
| [μg/g] | | | | | | | |
| Acid resistance test | N.A. | N.A. | N.A. | N.A. | N.A. | N.A. | N.A. |
| (DIN12116) [mg/dm²] | | | | | | | |
| Alkali resistance test | N.A. | N.A. | N.A. | N.A. | N.A. | N.A. | N.A. |
| (ISO695) [mg/dm²] | | | | | | | |
| Linear thermal expansion | 62.9 | 60.6 | 69.4 | 65.2 | N.A. | N.A. | N.A. |
| coefficient (20 to 300° C.) | | | | | | | |
| Liquidus temperature [° C.] | 990 | 960 | 995 | 955 | N.A. | N.A. | N.A. |
| log η at TL [dPa · s] | 5.7 | 5.9 | 5.5 | 5.7 | N.A. | N.A. | N.A. |

| [mol %] | No. 56 | No. 57 | No. 58 | No. 59 | No. 60 |
|---|---|---|---|---|---|
| SlO₂ | 77.6 | 78.3 | 79.1 | 79.8 | 78.6 |
| Al₂O₃ | 7.0 | 6.8 | 6.5 | 6.3 | 6.0 |
| B₂O₃ | 0.1 | 0.1 | 0.1 | 0.1 | 0.1 |
| Li₂O | 6.1 | 6.1 | 6.1 | 6.1 | 6.1 |
| Na₂O | 5.9 | 5.4 | 4.9 | 4.4 | 5.9 |
| K₂O | 2.7 | 2.7 | 2.7 | 2.7 | 2.7 |
| MgO | 0.0 | 0.0 | 0.0 | 0.0 | 0.0 |
| CaO | 0.0 | 0.0 | 0.0 | 0.0 | 0.0 |
| SrO | 0.0 | 0.0 | 0.0 | 0.0 | 0.0 |
| BaO | 0.0 | 0.0 | 0.0 | 0.0 | 0.0 |
| ZrO₂ | 0.5 | 0.5 | 0.5 | 0.5 | 0.5 |
| SnO₂ | 0.1 | 0.1 | 0.1 | 0.1 | 0.1 |
| Fe₂O₃ | 0.004 | 0.004 | 0.004 | 0.005 | 0.005 |
| TiO₂ | 0.011 | 0.011 | 0.011 | 0.011 | 0.011 |
| Cl | 0.018 | 0.018 | 0.016 | 0.016 | 0.019 |
| SiO₂ + Al₂O₃ + R₂O + | 99.3 | 99.3 | 99.3 | 99.3 | 99.3 |
| R′O | | | | | |
| R₂O | 14.7 | 14.2 | 13.7 | 13.2 | 14.7 |
| R′O | 0.0 | 0.0 | 0.0 | 0.0 | 0.0 |
| R₂O/Al₂O₃ | 2.100 | 2.088 | 2.108 | 2.095 | 2.450 |
| Li₂O/R₂O | 0.415 | 0.430 | 0.445 | 0.462 | 0.415 |
| Li₂O/CaO | — | — | — | — | — |
| CaO/R′O | — | — | — | — | — |
| CaO/(R₂O + R′O) | 0.000 | 0.000 | 0.000 | 0.000 | 0.000 |
| R′O/(R₂O + R′O) | 0.000 | 0.000 | 0.000 | 0.000 | 0.000 |
| SiO₂/Al₂O₃ | 11.086 | 11.515 | 12.169 | 12.667 | 13.100 |
| (R₂O + R′O − Al₂O₃)/ | 0.091 | 0.087 | 0.084 | 0.080 | 0.103 |
| (SiO₂ + Al₂O₃) | | | | | |
| Ps [° C.] | 477 | 478 | 481 | 485 | 469 |
| Ta [° C.] | 525 | 527 | 530 | 534 | 517 |
| Ts [° C.] | 775 | 780 | 787 | 797 | 763 |
| Working point (10^{4.0} | 1223 | 1230 | 1246 | 1257 | 1206 |
| dPa · s) [° C.] | | | | | |
| 10^{3.0} dPa · s [° C.] | 1466 | 1475 | 1494 | 1507 | 1446 |
| Hydrolytic resistance test | 37.8 | 36.3 | 34.4 | 32.9 | 42.8 |
| [μg/g] | | | | | |
| Acid resistance test | N.A. | N.A. | 0.46 | N.A. | N.A. |
| (DIN12116) [mg/dm²] | | | | | |
| Alkali resistance test | N.A. | N.A. | 52 | N.A. | N.A. |
| (ISO695) [mg/dm²] | | | | | |
| Linear thermal expansion | 70.5 | 69.2 | 66.7 | 64.5 | 70.6 |
| coefficient (20 to 300° C.) | | | | | |
| Liquidus temperature [° C.] | N.A. | N.A. | 800 | 846 | N.A. |
| log η at TL [dPa · s] | N.A. | N.A. | 7.4 | 7.0 | N.A. |

TABLE 6

| [mol %] | No. 61 | No. 62 | No. 63 | No. 64 | No. 65 | No. 66 | No. 67 | No. 68 | No. 69 |
|---|---|---|---|---|---|---|---|---|---|
| SiO₂ | 79.2 | 80.1 | 81.0 | 81.5 | 82.3 | 79.1 | 79.9 | 81.9 | 84.0 |
| Al₂O₃ | 5.8 | 5.5 | 5.3 | 5.0 | 4.8 | 5.3 | 5.0 | 4.0 | 3.5 |
| B₂O₃ | 0.1 | 0.1 | 0.1 | 0.1 | 0.1 | 0.1 | 0.1 | 0.1 | 0.1 |
| Li₂O | 6.1 | 6.1 | 6.1 | 6.1 | 6.1 | 4.8 | 4.8 | 6.1 | 6.1 |
| Na₂O | 5.5 | 4.9 | 4.3 | 4.1 | 3.5 | 2.7 | 2.7 | 4.7 | 3.1 |
| K₂O | 2.7 | 2.7 | 2.7 | 2.7 | 2.7 | 3.9 | 3.6 | 2.7 | 2.7 |
| MgO | 0.0 | 0.0 | 0.0 | 0.0 | 0.0 | 0.0 | 0.0 | 0.0 | 0.0 |
| CaO | 0.0 | 0.0 | 0.0 | 0.0 | 0.0 | 3.6 | 3.4 | 0.0 | 0.0 |
| SrO | 0.0 | 0.0 | 0.0 | 0.0 | 0.0 | 0.0 | 0.0 | 0.0 | 0.0 |
| BaO | 0.0 | 0.0 | 0.0 | 0.0 | 0.0 | 0.0 | 0.0 | 0.0 | 0.0 |
| ZrO₂ | 0.5 | 0.5 | 0.5 | 0.5 | 0.5 | 0.5 | 0.5 | 0.5 | 0.5 |
| SnO₂ | 0.1 | 0.1 | 0.0 | 0.0 | 0.0 | 0.0 | 0.0 | 0.0 | 0.0 |
| Fe₂O₃ | 0.005 | 0.004 | 0.005 | 0.005 | 0.005 | 0.005 | 0.005 | 0.004 | 0.004 |
| TiO₂ | 0.011 | 0.011 | 0.011 | 0.012 | 0.012 | 0.011 | 0.011 | 0.012 | 0.011 |
| Cl | 0.018 | 0.016 | 0.014 | 0.007 | 0.005 | 0.005 | 0.005 | 0.007 | 0.005 |
| SiO₂ + Al₂O₃ + R₂O + | 99.3 | 99.3 | 99.4 | 99.4 | 99.4 | 99.4 | 99.4 | 99.4 | 99.4 |
| R′O | | | | | | | | | |
| R₂O | 14.3 | 13.7 | 13.1 | 12.9 | 12.3 | 11.4 | 11.1 | 13.5 | 11.9 |
| R′O | 0.0 | 0.0 | 0.0 | 0.0 | 0.0 | 3.6 | 3.4 | 0.0 | 0.0 |
| R₂O/Al₂O₃ | 2.466 | 2.491 | 2.472 | 2.580 | 2.563 | 2.151 | 2.220 | 3.375 | 3.400 |
| Li₂O/R₂O | 0.427 | 0.445 | 0.466 | 0.473 | 0.496 | 0.421 | 0.432 | 0.452 | 0.513 |
| Li₂O/CaO | — | — | — | — | — | 1.333 | 1.412 | — | — |
| CaO/R′O | — | — | — | — | — | 1.000 | 1.000 | — | — |
| CaO/(R₂O + R′O) | 0.000 | 0.000 | 0.000 | 0.000 | 0.000 | 0.240 | 0.234 | 0.000 | 0.000 |
| R′O/(R₂O + R′O) | 0.000 | 0.000 | 0.000 | 0.000 | 0.000 | 0.240 | 0.234 | 0.000 | 0.000 |
| SiO₂/Al₂O₃ | 13.655 | 14.564 | 15.283 | 16.300 | 17.146 | 14.925 | 15.980 | 20.475 | 24.000 |
| (R₂O + R′O − Al₂O₃)/ | 0.100 | 0.096 | 0.090 | 0.091 | 0.086 | 0.115 | 0.112 | 0.111 | 0.096 |
| (SiO₂ + Al₂O₃) | | | | | | | | | |
| Ps [° C.] | 470 | 472 | 478 | 477 | 482 | 510 | 509 | 464 | 478 |
| Ta [° C.] | 518 | 521 | 527 | 527 | 533 | 557 | 557 | 513 | 529 |
| Ts [° C.] | 767 | 773 | 788 | 788 | 801 | 812 | 814 | 765 | 796 |
| Working point (10^{4.0} | 1210 | 1228 | 1240 | 1239 | 1257 | 1252 | 1261 | 1202 | 1247 |
| dPa · s) [° C.] | | | | | | | | | |
| 10^{3.0} dPa · s [° C.] | 1452 | 1469 | 1488 | 1488 | 1507 | 1485 | 1498 | 1440 | 1493 |
| Hydrolytic resistance test [μg/g] | 42.8 | 39.1 | 34.4 | 36.0 | 32.2 | 49.0 | 46.2 | 58.9 | 40.6 |
| Acid resistance test (DIN12116) | N.A. | 0.59 | N.A. | N.A. | N.A. | 0.26 | 0.36 | 0.27 | N.A. |
| [mg/dm²] | | | | | | | | | |
| Alkali resistance test (ISO695) | N.A. | 54 | N.A. | N.A. | N.A. | 48 | 47 | 52 | N.A. |
| [mg/dm²] | | | | | | | | | |
| Linear thermal expansion | 69.6 | 64.0 | 66.7 | 63.0 | 60.2 | 64.3 | 62.6 | 65.9 | 58.3 |
| coefficient (20 to 300° C.) | | | | | | | | | |
| Liquidus temperature [° C.] | 843 | 887 | 977 | 1002 | N.A. | 986 | 977 | N.A. | N.A. |
| log η at TL [dPa · s] | 6.7 | 6.3 | 5.7 | 5.5 | N.A. | 5.8 | 5.9 | N.A. | N.A. |

Each sample was prepared as follows. First, 550 g of a batch was mixed so as to have a glass composition shown in the tables, and the mixture was melted at 1550° C. for 2.5 hours using a platinum crucible. In order to enhance the homogeneity of the sample, stirring was performed twice in the melting process. Further, in order to enhance the homogeneity of the molten glass, the molten glass was water-crushed and dried, and then melted again at 1550° C. for 1 hour using a platinum crucible. After stirring once, the molten glass was melted at 1600° C. for 2 hours in order to reduce bubbles in the glass. Thereafter, the molten glass was poured out to produce an ingot, and the ingot was processed into a shape necessary for measurement and subjected to various evaluations. The results are shown in the tables.

The strain point Ps was determined by a fiber stretching method in accordance with ASTM C336. The annealing point Ta and the softening point Ts were obtained by a fiber stretching method in accordance with ASTM C388.

The working point (temperature at which the viscosity of the glass becomes 10^{4.0} dPa·s) and the temperature at which the viscosity of the glass becomes 10^{3.0} dPa·s were obtained by a platinum sphere pull up method.

For a hydrolytic resistance test, a hydrolytic resistance test (acetone washing) according to ISO 720 was performed. The detailed test procedure is as described above.

The acid resistance was evaluated by an acid resistance test according to YBB00342004, and the alkali resistance was evaluated by a test according to ISO 695.

The linear thermal expansion coefficient was measured in a temperature range of 20° C. to 300° C. by a dilatometer using a glass formed into a rod shape of about 5 mmφ×20 mm as a measurement sample.

The liquidus temperature was obtained by filling a ground glass into a platinum boat of about 120×20×10 mm, placing the platinum boat in an electric furnace having a linear temperature gradient for 24 hours, then specifying a crystal precipitation site by microscopic observation, and specifying a temperature corresponding to the crystal precipitation site from a temperature gradient graph of the electric furnace.

The liquidus viscosity log η at TL was obtained by obtaining a viscosity curve of the glass based on the strain point, the annealing point, the softening point, the working temperature, and the viscosity calculation formula of the Fulcher, and calculating the viscosity of the glass at the liquidus temperature from the viscosity curve.

As is clear from the tables, in Sample Nos. 1 to 69, the content of B₂O₃ in the glass composition was small, the working temperature was 1321° C. or less, and the elution amount of alkali by the hydrolytic resistance test was 102.9 μg/g or less.

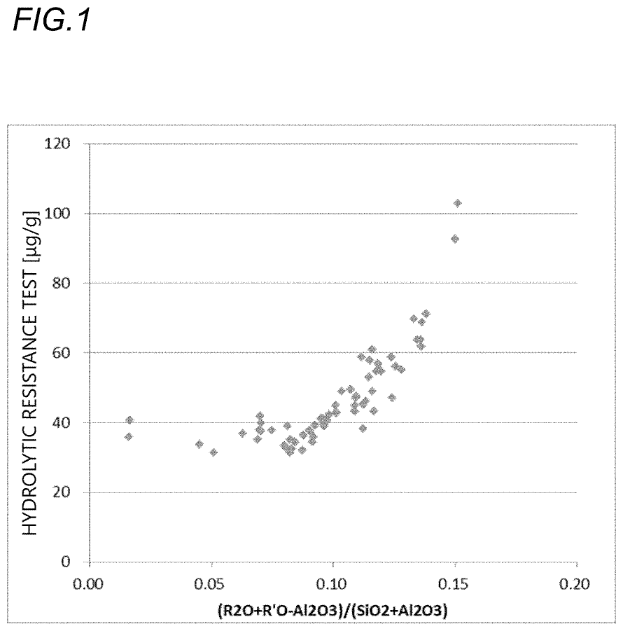

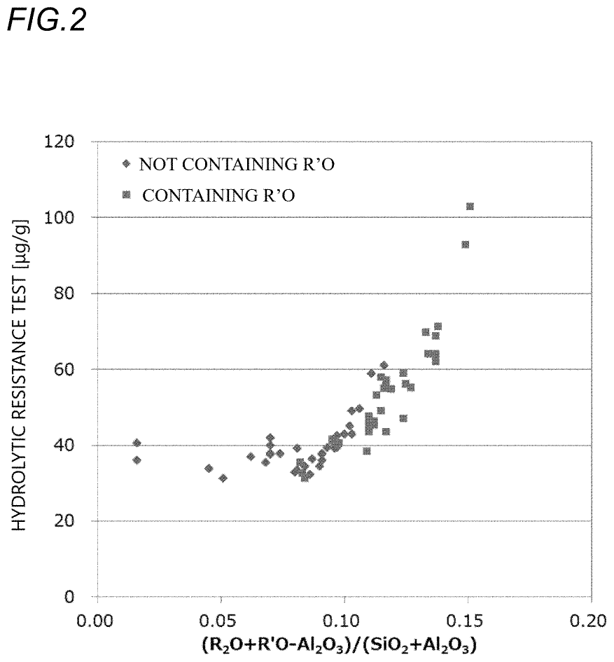

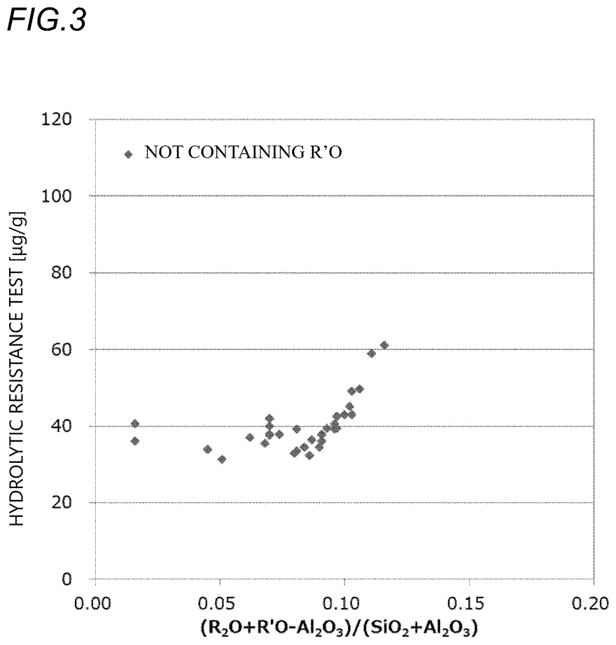

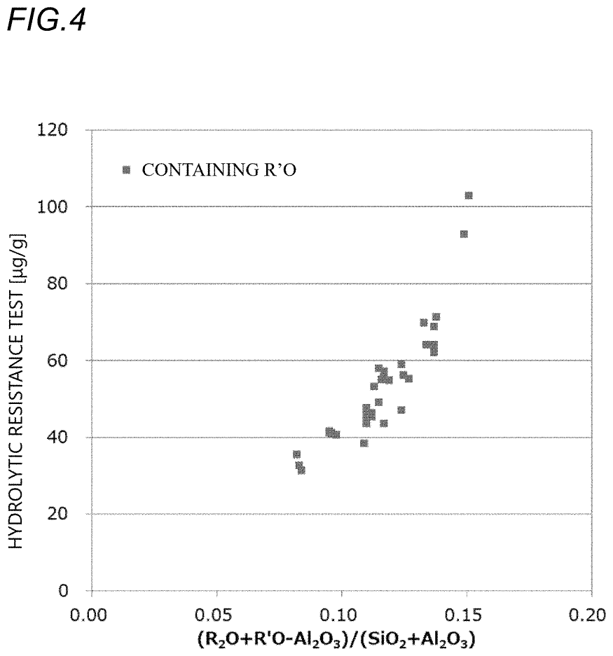

FIG. 1 is a graph obtained by plotting molar ratios (Li₂O+Na₂O+K₂O+MgO+CaO+SrO+BaO—Al₂O₃)/(SiO₂+Al₂O₃) of the glass samples on a horizontal axis, and hydrolytic resistance test data on a vertical axis. As can be seen from FIG. 1, there is a correlation between the molar ratio (Li₂O+Na₂O+K₂O+MgO+CaO+SrO+BaO—Al₂O₃)/(SiO₂+Al₂O₃) and the hydrolytic resistance. It can be seen that the smaller the molar ratio (Li₂O+Na₂O+K₂O+MgO+CaO+SrO+BaO—Al₂O₃)/(SiO₂+Al₂O₃) is, the better the hydrolytic resistance is. FIG. 2 is a graph showing the presence or absence of MgO+CaO+SrO+BaO in different plots in FIG. 1. FIG. 3 is a graph showing data of glass not containing MgO+CaO+SrO+BaO extracted from data shown in FIG. 1. FIG. 4 is a graph showing data of glass containing MgO+CaO+SrO+BaO extracted from the data shown in FIG. 1.

### INDUSTRIAL APPLICABILITY

The glass for a pharmaceutical container of the present invention is suitable as a glass for a pharmaceutical container for manufacturing a pharmaceutical container such as an ampoule, a vial, a prefilled syringe, and a cartridge, and is also applicable to a pharmaceutical container for an oral agent and bottles for beverages.

1. A glass for a pharmaceutical container, comprising, as a glass composition, in terms of mol %, 70% to 85% of SiO₂, 3% to 13% of Al₂O₃, 0% to 5% of B₂O₃, 0.1% to 18% of Li₂O+Na₂O+K₂O, and 0% to 10% of MgO+CaO+SrO+BaO, wherein a molar ratio (Li₂O+Na₂O+K₂O)/Al₂O₃ is 1 or more and a molar ratio (Li₂O+Na₂O+K₂O+MgO+CaO+SrO+BaO—Al₂O₃)/(SiO₂+Al₂O₃) is 0.2 or less.

2. The glass for a pharmaceutical container according to claim 1, wherein a content of Li₂O is 0 mol % to 8.1 mol %, a content of Na₂O is 0.1 mol % to 8 mol %, and a content of K₂O is 0.01 mol % to 5 mol %.

3. The glass for a pharmaceutical container according to claim 1, wherein a content of MgO+CaO+SrO+BaO is 0 mol % to 5 mol %.

4. The glass for a pharmaceutical container according to claim 1, wherein a content of MgO is 0 mol % to 1.5 mol %, a content of CaO is 0 mol % to 4 mol %, a content of SrO is 0 mol % to 0.3 mol %, and a content of BaO is 0 mol % to 0.3 mol %.

5. The glass for a pharmaceutical container according to claim 1, wherein the molar ratio Li₂O/(Li₂O+Na₂O+K₂O) is 0.6 or less.

6. The glass for a pharmaceutical container according to claim 1, wherein a molar ratio (Li₂O+Na₂O+K₂O)/Al₂O₃ is 2 or more.

7. The glass for a pharmaceutical container according to claim 1, wherein a molar ratio CaO/(Li₂O+Na₂O+K₂O+MgO+CaO+SrO+BaO) is less than 0.018.

8. The glass for a pharmaceutical container according to claim 1, wherein CaO is contained, and a molar ratio Li₂O/CaO is 3.1 or less.

9. The glass for a pharmaceutical container according to claim 1, wherein a content of SiO₂+Al₂O₃+Li₂O+Na₂O+K₂O+MgO+CaO+SrO+BaO is 90 mol % or more.

10. The glass for a pharmaceutical container according to claim 1, wherein a content of B₂O₃ is 0.01 mol % to 1 mol %.

11. The glass for a pharmaceutical container according to claim 1, wherein a content of ZrO₂ is 0 mol % to 2 mol %.

12. A glass for a pharmaceutical container, comprising, as a glass composition, in terms of mol %, 70% to 85% of SiO₂, 3% to 10% of Al₂O₃, 0% to 5% of B₂O₃, 0.1% to less than 13.9% of Li₂O+Na₂O+K₂O, and 0% to 10% of MgO+CaO+SrO+BaO, wherein a molar ratio Li₂O/(Li₂O+Na₂O+K₂O) is 0.5 or less, a molar ratio (Li₂O+Na₂O+K₂O)/Al₂O₃ is 2.0 or more, a molar ratio (Li₂O+Na₂O+K₂O+MgO+CaO+SrO+BaO—Al₂O₃)/(SiO₂+Al₂O₃) is 0.156 or less, and a molar ratio CaO/(Li₂O+Na₂O+K₂O+MgO+CaO+SrO+BaO) is less than 0.018.

13. A glass for a pharmaceutical container, comprising, as a glass composition, in terms of mol %, 70% to 85% of SiO₂, 3% to 10% of Al₂O₃, 0% to 5% of B₂O₃, 0.1% to less than 13.9% of Li₂O+Na₂O+K₂O, and CaO, wherein a molar ratio Li₂O/(Li₂O+Na₂O+K₂O) is 0.5 or less, a molar ratio (Li₂O+Na₂O+K₂O)/Al₂O₃ is 2.0 or more, a molar ratio (Li₂O+Na₂O+K₂O+MgO+CaO+SrO+BaO—Al₂O₃)/(SiO₂+Al₂O₃) is 0.156 or less, and a molar ratio Li₂O/CaO is 3.1 or less.

14. The glass for a pharmaceutical container according to claim 1, wherein a molar ratio (MgO+CaO+SrO+BaO)/(Li₂O+Na₂O+K₂O+MgO+CaO+SrO+BaO) is 0.06 or less.

15. A glass for a pharmaceutical container, comprising, as a glass composition, in terms of mol %, 75% to 85% of SiO₂, 3% to 13% of Al₂O₃, 0% to 4% of B₂O₃, 0.11% to 16% of Li₂O+Na₂O+K₂O, 0.1% to 15% of Na₂O, and 0.01% to 5% of K₂O, wherein a molar ratio (Li₂O+Na₂O+K₂O)/Al₂O₃ is 2 or more, a molar ratio (MgO+CaO+SrO+BaO)/(Li₂O+Na₂O+K₂O+MgO+CaO+SrO+BaO) is 0.06 or less, and a molar ratio (Li₂O+Na₂O+K₂O+MgO+CaO+SrO+BaO—Al₂O₃)/(SiO₂+Al₂O₃) is 0.2 or less.

16. The glass for a pharmaceutical container according to claim 1, wherein a molar ratio CaO/(MgO+CaO+SrO+BaO) is 0.5 or more.

17. A glass for a pharmaceutical container, comprising, as a glass composition, in terms of mol %, 70% to 85% of SiO₂, 3% to 13% of Al₂O₃, 0% to 5% of B₂O₃, 0.1% to 16% of Li₂O+Na₂O+K₂O, 0.1% to 15% of Na₂O, and 0.1% to 5% of MgO+CaO+SrO+BaO, wherein a molar ratio (Li₂O+Na₂O+K₂O)/Al₂O₃ is 2 or more, a molar ratio CaO/(MgO+CaO+SrO+BaO) is 0.5 or more, and a molar ratio (Li₂O+Na₂O+K₂O+MgO+CaO+SrO+BaO—Al₂O₃)/(SiO₂+Al₂O₃) is 0.2 or less.

18. The glass for a pharmaceutical container according to claim 1, wherein a molar ratio SiO₂/Al₂O₃ is 10 or more.

19. A glass for a pharmaceutical container, comprising, as a glass composition, in terms of mol %, 70% to 85% of SiO₂, 3% to 13% of Al₂O₃, 0% to 5% of B₂O₃, 0.21% to 16% of Li₂O+Na₂O+K₂O, 0.1% to 10% of Li₂O, 0.1% to 15% of Na₂O, 0.01% to 5% of K₂O, and 0% to 6% of MgO+CaO+SrO+BaO, wherein a molar ratio (Li₂O+Na₂O+K₂O)/Al₂O₃ is 1 or more, a molar ratio SiO₂/Al₂O₃ is more than 13.2, and a molar ratio (Li₂O+Na₂O+K₂O+MgO+CaO+SrO+BaO—Al₂O₃)/(SiO₂+Al₂O₃) is less than 0.155.

20. The glass for a pharmaceutical container according to claim 1, wherein a class in a hydrolytic resistance test (acetone washing) according to ISO 720 is at least HGA1.

21. The glass for a pharmaceutical container according to claim 1, wherein a working point is 1300° C. or less.

22. A glass tube for a pharmaceutical container, comprising the glass for a pharmaceutical container according to claim 1.

23. A pharmaceutical container comprising the glass for a pharmaceutical container according to claim 1.
